(19) United States
(12) Patent Application Publication
(10) Pub. No.: US 2026/0362078 A1
(43) Pub. Date: Nov. 12, 2026

(54) ACOUSTIC PROCESSING METHOD, ACOUSTIC PROCESSING APPARATUS, AND ACOUSTIC PROCESSING PROGRAM

(71) Applicant: Sony Group Corporation, Tokyo (JP)

(72) Inventors: Koya Sato, Kanagawa (JP); Kazuki Sakai, Tokyo (JP); Naoki Shinmen, Tokyo (JP); Natsuko Maeda, Kanagawa (JP)

(73) Assignee: Sony Group Corporation, Tokyo (JP)

(21) Appl. No.: 19/132,518

(22) PCT Filed: Nov. 16, 2023
(86) PCT No.: PCT/JP2023/041352

§ 371 Date: May 23, 2025

(30) Foreign Application Priority Data
Dec. 5, 2022 (JP) 2022-194448

(51) Int. Cl. H04S 7/00

(52) U.S. Cl. CPC H04S 7/305; H04S 7/302; H04S 2400/11; H04S 2400/13

(57) ABSTRACT

The acoustic processing method of the present disclosure includes diffraction path search processing and diffracted sound generation processing. In the diffraction path search processing, a diffraction path from a sound source to a sound receiving point is searched for. In the diffracted sound generation processing, the diffracted sound acquired at the sound receiving point is generated on a basis of the wave acoustic simulation in which the simulation time is constrained according to the distance of the diffraction path.

### FIELD

The present invention relates to an acoustic processing method, an acoustic processing apparatus, and an acoustic processing program.

### BACKGROUND

As virtual space technologies such as meta-verse and games develop, realistic experience based on reality is also required for sound reproduced on the virtual space. There are many studies for audibly recognizing a sound-emitting body in a three-dimensional space and techniques for simulating the sound-emitting body. Among them, a spatial sound field reproduction technology using physical simulation and the like are devised on the basis of physical phenomena in real space, and has high reproducibility in a case where the real space is reproduced on a virtual space in audibility, and is excellent in recognizability of the space even in a case where a sound in a space that does not actually exist is reproduced.

### CITATION LIST

### Patent Literature

Patent Literature 1: JP 2000-267675 A
Patent Literature 2: JP 2019-165845 A

### Non Patent Literature

Non Patent Literature 1: “Efficient and Accurate Sound Propagation Using Adaptive Rectangular Decomposition” N. Raghuvanshi et al., IEEE (2009)
Non Patent Literature 2: “Physics-informed neural networks: A deep learning framework for solving forward and inverse problems involving nonlinear partial differential equations” M. Raissi, P. Perdikaris, G. E. Karniadakis, Journal of Computational Physics 378 (2019)

### SUMMARY

### Technical Problem

There is a plurality of physical simulation methods in the acoustic field, such as wave acoustic simulation for modeling and calculating wave characteristics of sound, and geometric acoustic simulation for geometrically modeling and calculating energy propagation of sound.

The former is known to exhibit microscopic wave phenomena well, and is particularly advantageous in expression of a scattering phenomenon or the like when a sound wave collides with an object having a fine surface shape. Although the space is discretized and calculation is performed, the fineness of discretization affects the calculable frequency, and thus the calculation amount increases as the high-frequency calculation requires finer discretization.

As the latter, a sound ray method of tracking a trajectory of a sound ray emitted from a sound source, a virtual image method assuming propagation of a sound by geometric reflection at a boundary, and the like are known. Since the space division is not required, there is no correlation between the band and the calculation amount as in the wave acoustic simulation. However, since the wave nature of sound is ignored and the energy propagation is geometrically modeled, there is a disadvantage that it is difficult to simulate phenomena such as diffraction and scattering that remarkably appear particularly at low frequencies.

Therefore, the present disclosure proposes an acoustic processing method, an acoustic processing apparatus, and an acoustic processing program capable of providing a real sound experience with a small calculation amount.

### Solution to Problem

According to the present disclosure, an acoustic processing method executed by a computer that comprise: searching a diffraction path from a sound source to a sound receiving point; and generating a diffracted sound acquired at the sound receiving point on a basis of a wave acoustic simulation with a simulation time constrained according to a distance of the diffraction path. According to the present disclosure, an acoustic processing apparatus that performs information process defined in the acoustic processing method, and an acoustic processing program that realizes the information process defined in the acoustic processing method, are provided.

### BRIEF DESCRIPTION OF DRAWINGS

FIG. 1 is a diagram illustrating an overview of information processing according to a first embodiment.

FIG. 2 is a flowchart illustrating audio signal generation processing.

FIG. 3A is a diagram for explaining acoustic simulation in a virtual space.

FIG. 3B is a diagram for explaining an acoustic simulation in a virtual space.

FIG. 4 is a diagram schematically illustrating a state of reflection in acoustic simulation.

FIG. 5 is a diagram illustrating an example of a synthesized and output audio signal.

FIG. 6 is a flowchart illustrating a processing example in a case where there is a plurality of early reflected sounds, diffracted sounds, and transmitted sounds.

FIG. 7 is a diagram for explaining a diffraction phenomenon.

FIG. 8 is a diagram illustrating an example of a plug-in in which diffraction is expressed by LPF.

FIG. 9 is a diagram illustrating a plug-in screen expressing a diffraction phenomenon in Wwise.

FIG. 10 is a diagram illustrating an example of a configuration of a virtual space.

FIG. 11 is a diagram in which simulation is performed using FDTD or the like, only diffracted sound is extracted from an obtained impulse response, and frequency characteristics are displayed.

FIG. 12 is a diagram illustrating an example of a configuration of an acoustic processing apparatus.

FIG. 13 is a diagram illustrating an example of a processing flow.

FIG. 14 is a diagram illustrating an example of a processing flow using an AI model.

FIG. 15 is a diagram illustrating an example of a processing flow using a cloud.

FIG. 16 is a diagram for explaining features of audio signal generation processing of a second embodiment.

FIG. 17 is a diagram illustrating a configuration example of a subspace.

FIG. 18 is a diagram illustrating an example of a processing flow.

FIG. 19 is a diagram for explaining a processing example in a case where a real sound source is not included in a subspace.

FIG. 20 is a block diagram illustrating a flow of generation processing of diffracted sound.

FIG. 21 is a diagram illustrating an example of a processing flow.

FIG. 22 is a diagram illustrating an example in which a subspace is configured as a spherical or circular space centered on a diffraction site.

FIG. 23 is a diagram illustrating an example in which a real sound source and a real sound receiving point are outside a subspace.

FIG. 24 is a diagram for explaining an example of a method of setting a subspace for a complex object.

FIG. 25 is a diagram for explaining an example of a method of setting a subspace for a complex object.

FIG. 26 is a diagram for explaining features of audio signal generation processing of a third embodiment.

FIG. 27 is a diagram illustrating an example of directivity of a sound source.

FIG. 28 is a diagram for explaining a relationship between a size of a sound-emitting site and a diffracted sound.

FIG. 29 is a diagram for explaining a method of setting a subspace in a case where there is a gap between two objects.

FIG. 30 is a diagram for explaining a method of setting a subspace in a case where there is a gap between two objects.

FIG. 31 is a diagram for explaining an operation example in a case where a sound source and a sound receiving point are on the same coordinate plane.

FIG. 32 is a diagram illustrating an example of distance attenuation in a two-dimensional space and a three-dimensional space.

FIG. 33 is a diagram for explaining gain adjustment for each diffraction path.

FIG. 34 is a diagram illustrating an example in which diffraction paths exist in three directions.

FIG. 35 is a diagram for explaining an operation example in a case where a sound source and a sound receiving point are not on the same coordinate plane.

FIG. 36 is a diagram for explaining generation processing of diffracted sound passing through an edge of a side portion of an object.

FIG. 37 is a diagram for explaining generation processing of diffracted sound passing through an edge of a side portion of an object.

FIG. 38 is a diagram for explaining generation processing of diffracted sound passing through an edge of an upper portion of an object.

FIG. 39 is a diagram for explaining generation processing of diffracted sound passing through an edge of an upper portion of an object.

FIG. 40 is a diagram for explaining integration processing of a plurality of IRs (impulse responses) having different diffraction paths.

FIG. 41 is a diagram for explaining another calculation example in a case where a sound source and a sound receiving point are not on the same coordinate plane.

FIG. 42 is a diagram for explaining an example of IR generation based on encoded object information.

FIG. 43 is a hardware configuration diagram illustrating an example of a computer that implements functions of the acoustic processing apparatus.

### DESCRIPTION OF EMBODIMENTS

Hereinafter, embodiments of the present disclosure will be described in detail with reference to the drawings. In the following embodiments, the same parts are denoted by the same reference signs, and redundant description will be omitted.

Note that the description will be given in the following order.
[1. First Embodiment: Constraint on Simulation Time]
   [1-1. Overview of Information Processing]
   [1-2. Audio Signal Generation Processing by Acoustic Simulation]
   [1-3. Diffraction]
   [1-4. Features of Audio Signal Generation Processing of First Embodiment]
   [1-5. Configuration Example of Acoustic Processing Apparatus]
   [1-6. Processing Flow Example 1]
   [1-7. Processing Flow Example 2]
   [1-8. Processing Flow Example 3]
[2. Second Embodiment: Constraint on Simulation Space]
   [2-1. Features of Audio Signal Generation Processing of Second Embodiment]
   [2-2. Configuration Example of Subspace]
   [2-3. Relationship Between Real Sound Source and Real Sound Receiving Point and Subspace]
   [2-4. Delay/Gain Adjustment]
   [2-5. Processing Flow Example]
   [2-6. Circular/Spherical Subspace]
   [2-7. Setting Example of Size of Subspace]
[3. Third Embodiment: Generation of High-Order Diffracted Sound Based on Combination of Plurality of Subspaces]
[4. Modification 1: Constraint on Audio Signal Generation Processing Based on Directivity of Sound Source]
[5. Modification 2: Constraint on Audio Signal Generation Processing Based on Size of Sound-Emitting Site]
[6. Modification 3: Mesh Size of Subspace]
[7. Modification 4: Setting Example of Subspace According to Size of Gap Between Objects]
[8. Modification 5: Two-Dimensional Subspace]
   [8-1. Case Where Sound Source and Sound Receiving Point Are on Same Coordinate Plane]
   [8-2. Case Where Sound Source and Sound Receiving Point Are Not on Same Coordinate Plane]
[9. Modification 6: Generation of IR Based on Encoded Object Information]
[10. Hardware Configuration Example]
[11. Effects]

### 1. First Embodiment: Constraint on Simulation Time

### 1-1. Overview of Information Processing

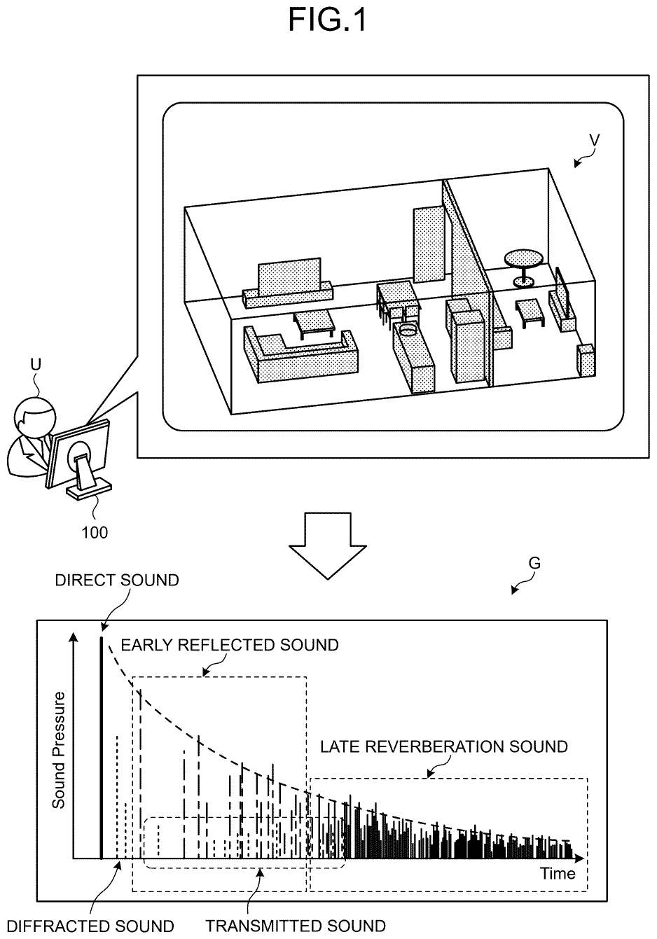

FIG. 1 is a diagram illustrating an overview of information processing according to a first embodiment.

The information processing of the present embodiment is executed by an acoustic processing apparatus 100 illustrated in FIG. 1. The acoustic processing apparatus 100 is an example of the acoustic processing apparatus according to the present disclosure. The acoustic processing apparatus 100 is, for example, an information processing apparatus such as a personal computer (PC), a server apparatus, a game machine, or a tablet terminal. The acoustic processing apparatus 100 is used by a user U who uses/creates content (for example, a game or a meta-verse) related to the virtual space.

Hereinafter, processing of audio information in a virtual three-dimensional space in a game content which is an interactive content by the user operation will be mainly described, but the acoustic processing apparatus 100 of the present disclosure can be used for combining videos and audio in advance, producing audio of a moving image content reproduced and viewed by the user U, producing a content including audio information reproducing the sound field in the virtual space, and presenting the audio information.

The acoustic processing apparatus 100 includes an output unit such as a display or a speaker, and outputs various types of information to the user U. For example, the acoustic processing apparatus 100 displays a virtual three-dimensional space (hereinafter, simply referred to as a “virtual space”) of a game or the like on a display, and outputs an audio signal generated by information processing of the present embodiment from a speaker. Alternatively, the acoustic processing apparatus 100 displays a user interface of software related to acoustic production on a display, and outputs an audio signal generated according to an operation of the user U from a speaker.

In the present embodiment, the acoustic processing apparatus 100 calculates how the sound output from the sound source object, which is the sound emission point of the sound, will be reproduced at the listening point (sound receiving point) in the virtual space, and reproduces the calculated sound. For example, the acoustic processing apparatus 100 performs acoustic simulation in a virtual space, and performs processing of bringing a sound emitted in the virtual space close to the real world or reproducing a sound desired by a sound designer.

FIG. 1 illustrates a virtual space V on a game. For example, the virtual space V is displayed on a display included in the acoustic processing apparatus 100. In the virtual space V, a listening point (sound receiving point) is set together with the position (coordinates) of the sound source object (sound emission point). The listening point is a position at which the user U virtually listens to sound in the virtual space V1. In a real space, a difference occurs between a sound observed near a sound source and a sound observed at a listening point due to various physical phenomena. Therefore, the acoustic processing apparatus 100 virtually reproduces (simulates) an actual physical phenomenon in the virtual space V, and generates an audio signal suitable for the space so as to enhance the realistic feeling of the sound that the user U experiences in the virtual space V.

Here, the audio signal generated by the acoustic processing apparatus 100 will be described. The graph G schematically illustrates the intensity of the sound when the pulsed sound emitted from the sound source object is observed at the listening point. At the listening point, first, a direct sound is observed, and then, a diffracted sound or the like of the direct sound is observed. Thereafter, the primary reflected sound reflected at the boundary of the virtual space, the transmitted sound transmitted through the object, and the like are observed at the listening point. The reflected sound is observed each time the sound is reflected at the boundary, and for example, a reflected sound of a first order to a third order which is regarded as an early reflected sound is observed. Thereafter, at the listening point, high-order reflected sound regarded as late reverberation sound is observed. Since the sound emitted from the sound source attenuates over time, the graph G draws an envelope (attenuation curve) that peaks at the direct sound and asymptotically approaches 0.

### 1-2. Audio Signal Generation Processing by Acoustic Simulation

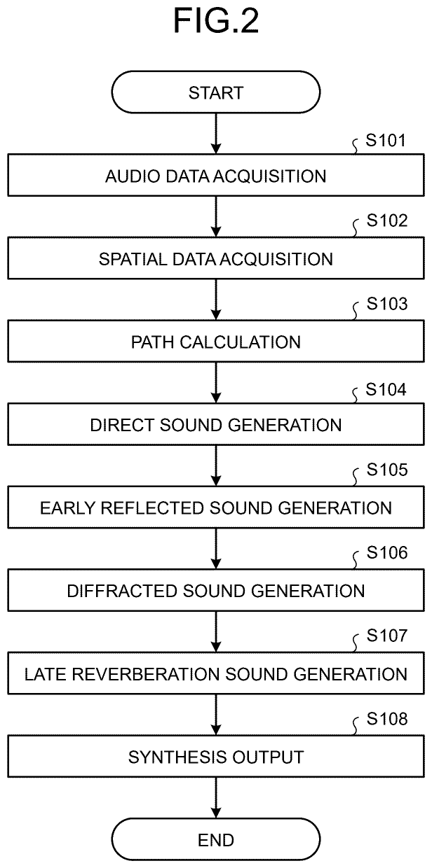

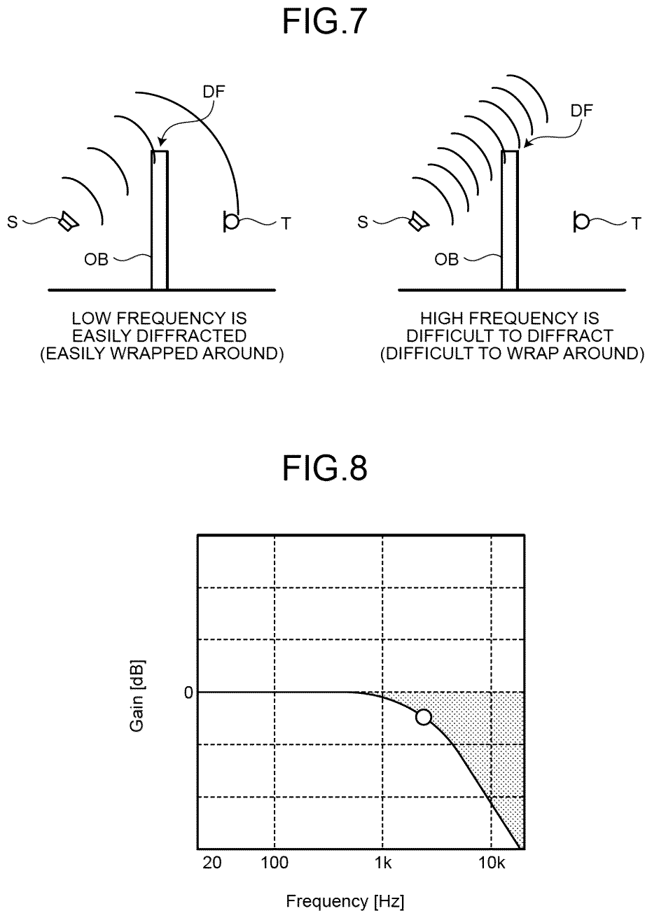

Hereinafter, information processing executed by the acoustic processing apparatus 100 will be described in detail with reference to the drawings. First, general generation processing of an audio signal in a virtual space will be described with reference to FIGS. 2 to 6. Thereafter, the acoustic processing according to the present embodiment will be described in detail with reference to FIG. 7 and subsequent drawings.

First, general generation processing of an audio signal in a virtual space will be described. FIG. 2 is a flowchart illustrating audio signal generation processing according to the present embodiment. The audio signal generation processing is started by an event (for example, an event that occurs due to the operation of the user U/the progress of the game) in the virtual three-dimensional space.

In the following description, it is assumed that the acoustic processing apparatus 100 executes the audio signal generation processing, but the audio signal generation processing may be executed by one computer or may be executed by a plurality of computers in cooperation. For example, one computer (for example, the server apparatus) among a plurality of computers (for example, the user terminal and the server apparatus) connected via a network may execute some steps of the audio signal generation processing, and the other computer (for example, the user terminal) may execute the remaining steps.

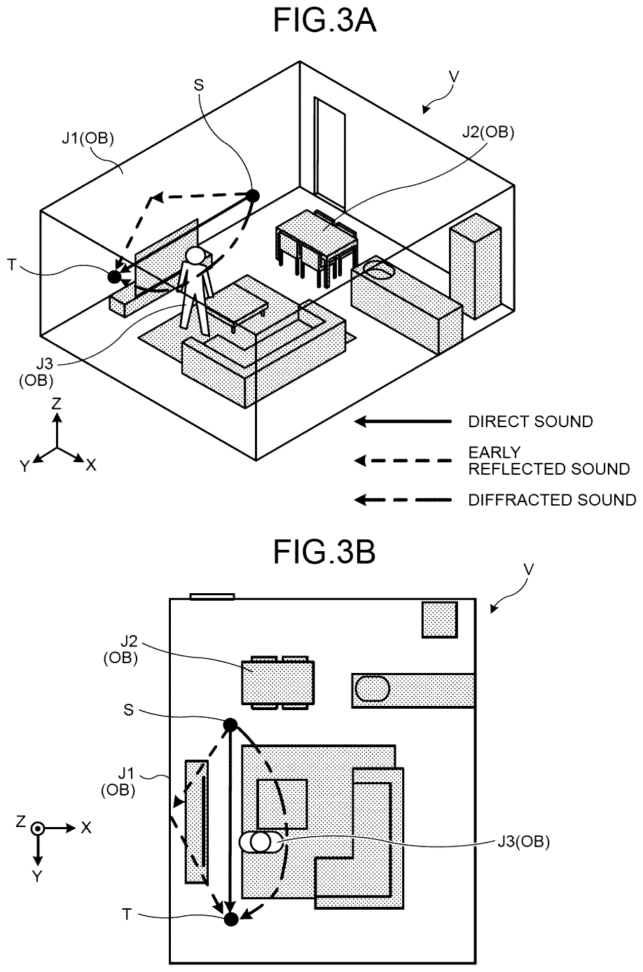

Note that, in the following description, a scene in a game is assumed as an example. Specifically, the virtual space V illustrated in FIGS. 3A and 3B is assumed. FIGS. 3A and 3B are diagrams for explaining an acoustic simulation in a virtual space. The virtual space V is a virtual three-dimensional space such as a game. FIG. 3A is a perspective view of the virtual space V, and FIG. 3B is a plan view of the virtual space V. Note that, in the following description, an XYZ coordinate system may be used for description in order to facilitate understanding. In the figure, an X-axis direction and a Y-axis direction are horizontal directions, and a Z-axis direction is a vertical direction.

In the virtual space V2, a sound emission point at a position to be the sound source S and a listening point to be the sound receiving point T are set. The sound source S is an object (that is, an object that can be a sound source) that emits an arbitrary sound with respect to the sound receiving point T. For example, the sound emission point is coordinates at which the sound source object is arranged. In addition, the sound receiving point T is a position at which the sound output from the sound source S is observed. For example, the sound receiving point T is a position where the game character operated by the user U is located (more specifically, coordinates of a position corresponding to the head of the game character).

In addition, a plurality of three-dimensional objects OB is arranged in the virtual space V. For example, in the virtual space V, an object J2 which is a furniture type object OB and an object J3 which is a human type object OB are arranged. Furthermore, in the virtual space V, a wall J1 or the like serving as a boundary forming the virtual space V is also arranged. Note that, since acoustic characteristics as described later are also set in the boundary such as the wall J1, in the present embodiment, the boundary such as the wall J1 is also treated as one of the objects OB arranged in the virtual space V.

In the example of FIGS. 3A and 3B, a sound is generated at the position of the sound source S. The acoustic processing apparatus 100 generates an audio signal at the sound receiving point T while considering the propagation characteristic of the sound in the virtual space V. Hereinafter, the audio signal generation processing of the present embodiment will be described with reference to the flowchart of FIG. 2.

First, the acoustic processing apparatus 100 acquires audio data of a sound emitted from the sound source S (step S101). The acoustic processing apparatus 100 acquires audio data in which sound to be emitted is recorded in advance when a sound emission event with the sound source S is started. The audio data is, for example, audio data recorded in a library in the game. Note that the audio data is preferably data not including reverberation or the like (dry source) in consideration of being subjected to signal processing in the subsequent stage. On the other hand, a simple sound presentation in which a part of the signal processing in the subsequent stage is omitted or a wet source to which reverberation or the like is added for expressing a characteristic tone may be used. Furthermore, the acoustic processing apparatus 100 may not only refer to the audio data from the library but also acquire audio data generated as needed such as a synthesizer. Alternatively, the acoustic processing apparatus 100 may acquire audio data generated as needed by simulating a sound from a structural physical simulation using a finite element method (FEM) or the like.

Next, the acoustic processing apparatus 100 acquires spatial data of a space where the sound source S and the sound receiving point T exist (step S102). For example, the acoustic processing apparatus 100 acquires three-dimensional data of the virtual space V and metadata (for example, material information) added to the three-dimensional data. The three-dimensional data includes, for example, coordinates indicating a boundary shape such as a wall surface of the virtual space V and coordinates of an object or the like arranged inside the virtual space V. In a case where the sound source S and the sound receiving point T exist in a closed space, the acoustic processing apparatus 100 acquires three-dimensional data of the entire closed space or three-dimensional data of the entire space on the path from the sound source S to the sound receiving point T and the entire space continuous with the space. Note that, since the data amount increases when the three-dimensional data includes a detailed texture for video display, the acoustic processing apparatus 100 may acquire data in which the color information, the fine shape of the surface, and the like are simplified in a form in which acoustic parameters necessary for the physical simulation in the subsequent stage can be maintained. The three-dimensional data used for the path search described later is preferably polygon information that does not include fine surface irregularities (for example, polygon information to which no texture is applied).

Next, the acoustic processing apparatus 100 calculates a sound path from the sound source S to the sound receiving point T (step S103). For example, the acoustic processing apparatus 100 calculates the propagation path of the sound from the sound source S to the sound receiving point T using the acquired three-dimensional data. At this time, the direct sound path is a line-of-sight path from the sound source S to the sound receiving point T. Note that, in a case where a transmission phenomenon such as a wall is included, even in a case where there is no line-of-sight path, a path including an obstacle is calculated. In the examples of FIGS. 3A and 3B, the propagation path of the direct sound from the sound source S to the sound receiving point T is indicated by a solid line.

In addition, the acoustic processing apparatus 100 calculates a path including a reflection boundary and the like until the early reflected sound reaches the sound receiving point T. For example, the acoustic processing apparatus 100 obtains the propagation path of the early reflected sound using a sound ray method or the like which is a geometric physical simulation method. Note that, in the present embodiment, the early reflected sound includes not only a sound that reaches the sound receiving point T after being reflected once on the boundary surface, but also a sound that reaches the sound receiving point T after being reflected a small number of times, such as twice or three times.

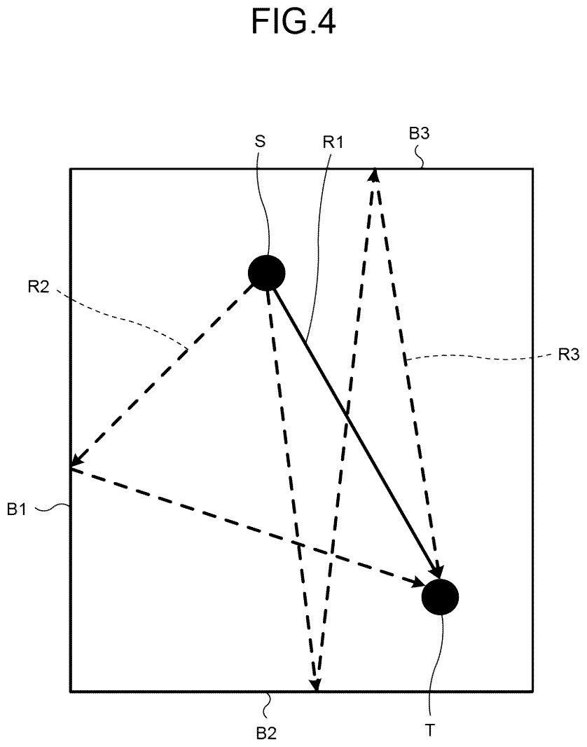

FIG. 4 illustrates an example of a propagation path calculated by the acoustic processing apparatus 100. FIG. 4 is a diagram schematically illustrating a state of reflection in acoustic simulation. In the example illustrated in FIG. 4, the path R1 is a direct sound propagation path from the sound source S to the sound receiving point T. In addition, the path R2 is a propagation path of the primary reflected sound that is reflected once at the boundary B1 and reaches the sound receiving point T. In addition, the path R3 is a propagation path of the secondary reflected sound that is reflected twice at the boundary B2 and the boundary B3 and reaches the sound receiving point T. In FIG. 4, the paths R1 to R3 are illustrated as propagation paths. However, actual calculation includes reflection on a floor surface, a ceiling surface, other wall surfaces, an object surface, and the like.

The diffracted sound reaching the sound receiving point T from the sound source S is obtained by bypassing the end portion of the obstacle located between the sound source S and the sound receiving point T in addition to the shortest path from the sound source S to the sound receiving point T. In the examples of FIGS. 3A and 3B, the object J3 is an example of an obstacle located between the sound source S and the sound receiving point T. In this case, for example, the acoustic processing apparatus 100 can obtain the detour path bypassing the obstacle in an arc shape, and can also obtain the detour path by a method of connecting the sound source S and the end portion of the object J3 and the end portion of the object J3 and the sound receiving point T with straight lines.

In a case where the directivity is set for the sound source, the acoustic processing apparatus 100 may omit the sound ray in the direction in which there is no sound radiation according to the directivity, or may change the density of the sound ray according to the intensity of radiation. By performing this processing, it is possible to reduce subsequent processing performed for each path while reducing the influence on audibility.

On the basis of the obtained information, the acoustic processing apparatus 100 generates an audio signal to be heard at the sound receiving point T. For example, the acoustic processing apparatus 100 performs generation processing such as direct sound generation, early reflected sound generation, diffracted sound generation, and late reverberation sound generation. Hereinafter, these generation processes will be described.

First, the acoustic processing apparatus 100 generates an audio signal based on a direct sound among audio signals heard at the sound receiving point T (step S104). Specifically, the acoustic processing apparatus 100 uses the acquired audio data as an input, and generates an audio signal using the spatial size and directivity of the sound source, attenuation according to the distance from the sound source to the listening point, and a shift of the observation time due to the propagation time as parameters. For example, in a case where the sound source S is an omnidirectional point sound source and the distance between the sound source S and the sound receiving point T is x, the attenuation amount is obtained by 20 log₁₀x. In addition, the propagation time is obtained by dividing the distance x by the sound speed c. Note that, in a case where the content creator desires expression emphasizing the sense of distance between the sound source S and the sound receiving point T, the acoustic processing apparatus 100 can change the attenuation amount without being bound by the physical phenomenon in the real space.

Subsequently, the acoustic processing apparatus 100 generates an audio signal based on the early reflected sound among the audio signals heard at the sound receiving point T (step S105). Specifically, the acoustic processing apparatus 100 uses the acquired audio data as an input, and calculates attenuation and a time shift according to a propagation path length in a medium on the basis of a propagation path calculated in advance similarly to the case of direct sound. Furthermore, the acoustic processing apparatus 100 performs signal processing simulating reflection at the boundary surface on the basis of information on the boundary surface reflecting on the input signal. For example, the acoustic processing apparatus 100 may apply predetermined attenuation for each frequency according to the sound absorption coefficient of the boundary surface reflecting on the input signal.

For example, for the reflected sound corresponding to the path R2 illustrated in FIG. 4, the section from the sound source S to the boundary B1 and the section from the boundary B1 to the sound receiving point T can be regarded as the propagation path of the medium. The acoustic processing apparatus 100 obtains the attenuation and the time shift from each distance of the propagation path. Note that the acoustic processing apparatus 100 may calculate attenuation by holding sound absorption coefficient data or the like for each frequency in a library in advance for the boundary B1 and appropriately reading the data. The acoustic processing apparatus 100 may generate the audio signal of the reflected sound corresponding to the path R2 by giving attenuation according to the sound absorption coefficient to the input signal together with attenuation on the preceding propagation path. At this time, in a case where the influence of plate vibration or resonance at the boundary B1 and a non-linear phenomenon are not considered, the acoustic processing apparatus 100 may calculate attenuation or the like by adding the section from the sound source S to the boundary B1 and the propagation path from the boundary B1 to the sound receiving point T.

Similarly, the acoustic processing apparatus 100 performs calculation for the reflected sound corresponding to the path R3 illustrated in FIG. 4. That is, the acoustic processing apparatus 100 performs calculation according to the propagation path from the sound source S to the boundary B2, from the boundary B2 to the boundary B3, and from the boundary B3 to the sound receiving point T. When calculating sounds reflected at a plurality of boundary surfaces such as the boundary B2 and the boundary B3, the acoustic processing apparatus 100 may collectively calculate attenuation according to the sound absorption coefficient in a case where non-linear behavior according to the sound pressure or the like at the boundary surface is not considered. For example, a digital filter such as an infinite impulse response (IIR) or a finite impulse response (FIR) may be used to calculate attenuation for each frequency according to the sound absorption coefficient. Note that, in the processing of generating the early reflected sound, the acoustic processing apparatus 100 may appropriately simulate the state of reflection on each wall surface using a method such as ray tracing.

Subsequently, the acoustic processing apparatus 100 generates an audio signal related to the diffracted sound (step S106). Similarly to the early reflected sound, the acoustic processing apparatus 100 generates an audio signal related to the diffracted sound by using a geometric method of calculating attenuation or time shift on the basis of a propagation path. Note that it is known that the attenuation amount of the diffracted sound increases as the frequency increases in the sound diffraction phenomenon. Therefore, the acoustic processing apparatus 100 may generate the diffracted sound by applying filters having different attenuation amounts according to frequencies. Note that, if a more accurate method based on the physical law of the wave phenomenon is adopted, the acoustic processing apparatus 100 can use not only the above-described geometric simulation method but also a wave acoustic simulation method from the sound source S to the sound receiving point T. In this case, since there is a possibility that the calculation amount increases as compared with the geometric simulation, the user U may use equipment having sufficient calculation capability as the acoustic processing apparatus 100 or prepare a library in which characteristics of a representative propagation path shape are calculated in advance.

Subsequently, the acoustic processing apparatus 100 generates late reverberation sound (step S107). The late reverberation sound refers to a portion of the sound emitted from the sound source S that reaches the sound receiving point T by repeating reflection and diffraction in the space, excluding the early reflected sound. This reflection or diffraction continues until the sound is completely attenuated (for example, a state in which the quantization error on the computer can be regarded as 0). Here, the state in which the sound is attenuated may be a state in which the listener operates the user interface of the acoustic processing apparatus 100 with respect to the reproduction sound including the late reverberation sound generated on the acoustic processing apparatus 100, and the state is determined as a discrimination limit in the perception of the listener.

Note that, in simulation, it is also possible to perform calculation until the sound is completely attenuated. However, since the calculation amount increases for each number of times of reflection, the acoustic processing apparatus 100 may calculate the early reflected sound by regarding up to a predetermined number of times of reflection as early reflection. Then, the acoustic processing apparatus 100 may calculate the subsequent sounds by another method and synthesize the calculated sounds with the early reflected sound or the like. Here, the predetermined number of reflections included in the early reflected sound may be set on the creator side, or may be dynamically changed and set in the acoustic processing apparatus 100 according to the content to be reproduced, the type of the virtual space, the size of the space, the boundary surface in the space, the sound absorption coefficient on the object surface, and the like. Note that, as a method of calculating the late reverberation sound, a method of calculating the reverberation time by a statistical method from the size of the space, the boundary surface in the space, the sound absorption coefficient on the object surface, and the like is also known in the field of building acoustics.

Regarding the generation of the late reverberation sound, the acoustic processing apparatus 100 can use a method of using a comb filter in which acquired audio data is input, feedback is performed on the input by multiplying a predetermined gain, and the input signal is repeated at a constant cycle while being attenuated, a method of convolving data of an impulse response held in a library or the like with respect to the input signal, or the like. Note that the acoustic processing apparatus 100 may generate late reverberation sound using other known techniques. As described above, the late reverberation sound has a great influence on the audibly recognizing space of the user, and thus has important significance in content production. In many existing modularized reverberation generators, it is possible to adjust a late reverberation level, a late reverberation delay time, an attenuation time, a ratio of attenuation amounts for each frequency, an echo density, a modal density, and the like as late reverberation sound settings (parameters).

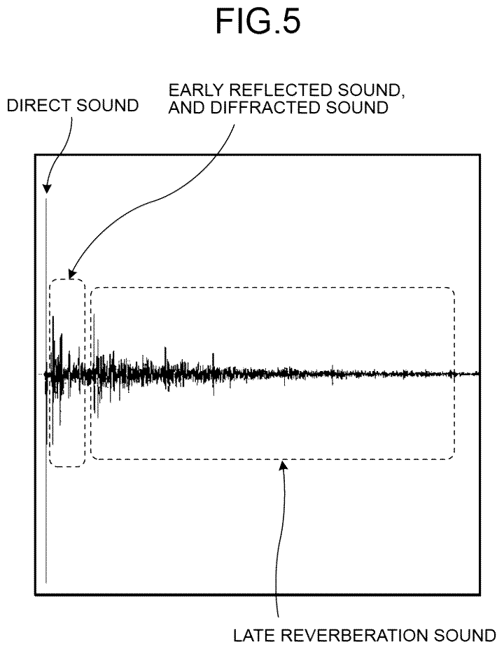

The acoustic processing apparatus 100 generates each of direct sound, early reflected sound, diffracted sound, and late reverberation sound, and then synthesizes these signals. Then, the acoustic processing apparatus 100 outputs the synthesized audio signal to a speaker or the like as a sound observed at the sound receiving point T (step S108). FIG. 5 is a diagram illustrating an example of synthesized and output audio signals. When the output is completed, the acoustic processing apparatus 100 ends the audio signal generation processing.

Note that the generation processing according to steps S104 to S106 described above does not depend on the order between the respective steps, and thus may be replaced. Furthermore, when considering a case where diffraction occurs after reflection in a propagation path, a signal generated by calculating reflection attenuation at a boundary from a sound source first may be used as an input in calculation of a diffracted sound.

Note that, although not taken into consideration in the example of FIG. 3, the acoustic processing apparatus 100 may add processing using a transmission simulation of a sound of a boundary surface or a porting simulation technique that simulates characteristics when a small sound passes through a space such as a window or a door of a building. As a result, the acoustic processing apparatus 100 can implement sound expression closer to the phenomenon of the real space.

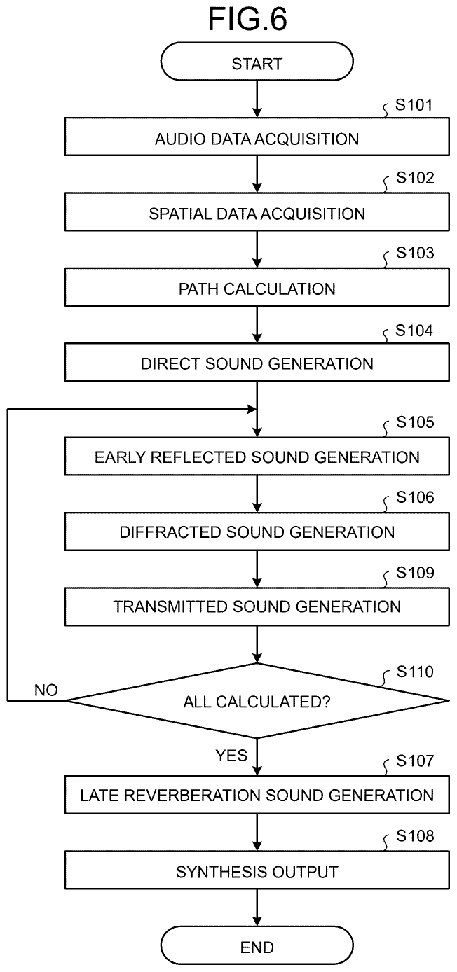

Furthermore, in a case where a plurality of reflected sounds, a plurality of diffracted sounds, and a plurality of transmitted sounds are present on the path, the acoustic processing apparatus 100 may perform these calculations for each place where each phenomenon occurs, and may synthesize and output the audio signal after all the calculations are performed. FIG. 6 is a flowchart illustrating a processing example in a case where there is a plurality of early reflected sounds, diffracted sounds, and transmitted sounds. The audio signal generation processing illustrated in FIG. 6 may be executed by one computer or may be executed by a plurality of computers in cooperation.

Compared with the flowchart illustrated in FIG. 2, steps S109 and S110 are newly added to the flowchart illustrated in FIG. 6. That is, the acoustic processing apparatus 100 also processes the transmitted sound in addition to the processing of the direct sound, the early reflected sound, and the diffracted sound. Specifically, the acoustic processing apparatus 100 generates an audio signal based on the diffracted sound and then generates an audio signal based on the transmitted sound (step S109). Then, the acoustic processing apparatus 100 discriminates whether all of the early reflected sound, the diffracted sound, and the transmitted sound have been calculated (step S110). In a case where all the values have not been calculated (step S110: No), the acoustic processing apparatus 100 returns the processing to step S105. In a case where all the values have been calculated (step S110: Yes), the acoustic processing apparatus 100 advances the processing to step S107. Note that the generation processing in steps S104, S105, S106, and S109 described above can be interchanged.

Note that, in a case where there is a plurality of sound sources S, the acoustic processing apparatus 100 may process the entire processing described above in parallel for the sounds output from the plurality of sound sources S. Alternatively, the acoustic processing apparatus 100 may delay the time until the output until the entire processing is completed and sequentially perform the processing, and further synthesize and output each synthesis signal in which the time series of the arrival sound at the sound receiving point T is aligned.

### 1-3. Diffraction

The overall flow of signal generation and reproduction has been described above. Hereinafter, the description will be given focusing on the diffraction phenomenon as a point of the present disclosure.

In the present disclosure, attention is focused on realistically reproducing a phenomenon such as diffraction in which a sound wave goes around to the back side of an obstacle when the sound wave is incident on an object OB such as the obstacle, or fine scattering and interference generated in the vicinity where the diffraction occurs using a wave acoustic simulation method in the above-described audio signal generation processing. As described above, the wave acoustic simulation has a problem of high calculation load, but in the present disclosure, in order to improve such a problem, temporal or spatial constraints is applied to the wave acoustic simulation. This can improve the huge calculation amount in the wave acoustic simulation and provide the user U with a more natural tonal diffraction phenomenon.

First, the diffraction phenomenon will be described. FIG. 7 is a diagram for explaining a diffraction phenomenon. The diffraction phenomenon refers to a phenomenon in which sound goes around to the back side of an object OB in a case where there is the object OB as an obstacle as illustrated in FIG. 7. The edge of the object OB is the diffraction site DF. The diffraction site DF means a continuous region where a diffraction phenomenon occurs. The diffraction phenomenon is related to the wavelength of sound, and has a property that the attenuation amount decreases as the frequency decreases and the attenuation amount increases as the frequency increases. In the virtual space V of a game or the like, there are many scenes where there are obstacles between the sound source S and the sound receiving point T, and it is important to reproduce and generate a diffracted sound without discomfort.

The sound experience for the user U in the virtual space V such as a game is generally generated by geometric acoustic-based simulation such as a virtual image method or a sound ray method. While the geometric acoustic-based simulation has an advantage that the calculation amount is smaller than that of the wave acoustic-based simulation, there is a disadvantage that it is difficult to simulate phenomena such as diffraction and scattering that remarkably appear particularly at low frequencies because the simulation is a method in which the wave nature of sound is ignored and energy propagation is geometrically modeled.

As a method of expressing geometric acoustic-based diffraction, a geometric acoustic model using uniform theory of diffraction (UTD) was published as “Modeling Acoustics in Virtual Environments Using the Uniform Theory of Diffraction, N. Nicolas, T. Funkhouser, A. Ngan, I. Carlbom” in 2001. However, the UTD is a theoretical model in which an edge of an obstacle where diffraction occurs is assumed to have an infinite length, and since there is actually no obstacle whose edge has an infinite length, this theoretical model causes a larger error as the edge becomes shorter.

As described above, a model using the UTD has been studied, but in audio middleware used in an actual game or the like, a diffraction phenomenon is simply implemented by a simple low pass filter (LPF) expressing an infinite impulse response (IIR) type. As described above, since the diffraction phenomenon has a small attenuation amount of sound at low frequencies and has a large attenuation amount at high frequencies, the diffraction phenomenon can be easily implemented by LPF.

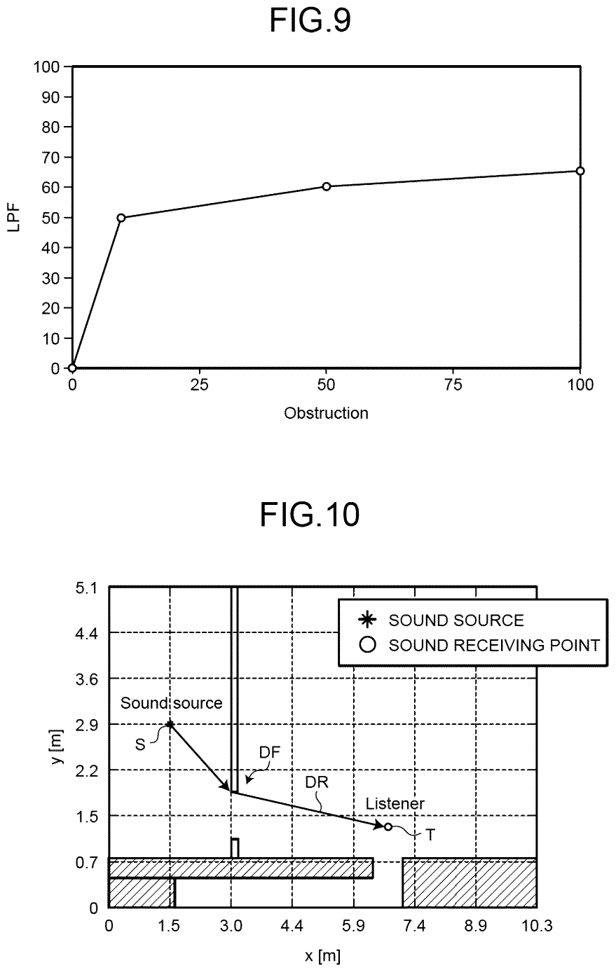

FIG. 8 illustrates an example of a plug-in in which diffraction is expressed by LPF. In this LPF, a frequency lower than about 1 kHz is set to have a sound volume as it is, and a frequency higher than about 1 kHz is set to be decreased by −6 dB every time the frequency is increased by 1 octave. Furthermore, FIG. 9 illustrates a plug-in screen expressing a diffraction phenomenon in the audio middleware Wave Works Interactive Sound Engine (Wwise) used in games and the like. Although it looks different from FIG. 8 at a glance, it can be seen that the vertical axis represents the amount to which the LPF is applied, the horizontal axis represents the size of the obstacle, and the diffraction is expressed by the LPF.

As described above, the diffraction phenomenon is generally reproduced by a simple LPF, and the diffracted sound generated by the LPF is greatly different from the actual diffracted sound and causes a feeling of discomfort, which diminishes the immersive feeling of the user U. In a game, when a character moves behind an obstacle, the sound suddenly changes due to the LPF, and thus there are many scenes where the user feels discomfort.

### 1-4. Features of Audio Signal Generation Processing of First Embodiment

As described above, it is difficult to express the diffracted sound well by the geometric acoustic-based simulation using the UTD. Therefore, in the present invention, a diffracted sound is generated by a wave acoustic-based simulation based on a wave equation. The wave equation is expressed by the following equation (1) in the three-dimensional orthogonal coordinate system.

$$( \frac{{\partial }^{2} p}{\partial {x}^{2}} + \frac{{\partial }^{2} p}{\partial {y}^{2}} + \frac{{\partial }^{2} p}{\partial {z}^{2}} ) = \frac{1}{{c}^{2}} \frac{{\partial }^{2} p}{\partial {t}^{2}} \qquad ( 1 )$$

Here, p is a sound pressure, c is a sound speed, t is time, and x, y, and z are variables in a three-dimensional orthogonal coordinate system. As a simulation method based on this wave equation, there is a finite-difference time-domain method (FDTD). The FDTD can obtain a solution by discretizing a space and time to be simulated, expanding each differential term of the wave equation into a difference equation, and performing sequential calculation. In the FDTD, calculation is performed using a staggered grid that gives sound pressure and particle velocity in a half-integer coordinate system. Here, the FDTD has been described as a simulation method based on the wave equation in the time domain, but a finite element method (FEM) or a boundary element method (BEM) may be used.

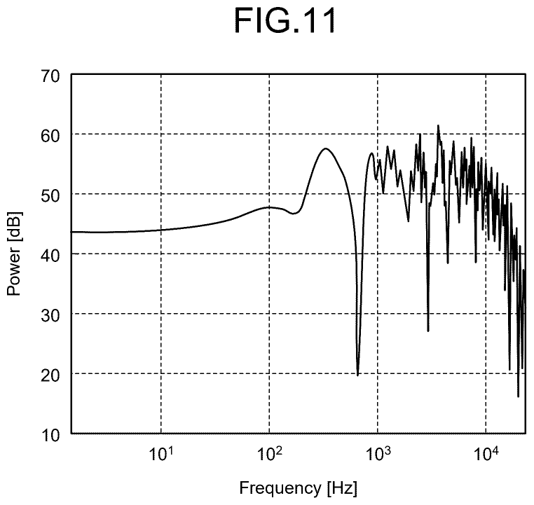

Since the wave acoustic-based simulation can express the diffraction phenomenon, it is possible to provide the user U with a more natural tone than the diffracted sound created on the conventional geometric acoustic basis or by the IIR. As an example, FIG. 11 illustrates frequency characteristics from the sound source S to the sound receiving point T in the virtual space V of FIG. 10. FIG. 10 is a diagram illustrating an example of a configuration of the virtual space V. FIG. 11 is a diagram in which a simulation is performed using FDTD or the like, only a diffracted sound is extracted from an obtained impulse response (IR), and frequency characteristics are displayed.

As can be seen from FIGS. 10 and 11, even such a simple diffraction phenomenon has complex frequency characteristics. The reason for having such complex frequency characteristics is that fine scattering or reflection occurs at an edge portion where diffraction occurs. It can be seen that the frequency characteristic is greatly different from the frequency characteristic expressing the diffraction phenomenon by the LPF in FIG. 8. As described above, a more realistic natural diffracted sound can be presented to the user U by simulating the diffraction phenomenon on the wave acoustic basis.

In general, FDTD or the like discretizes the entire space, and sequentially calculates each time step up to a certain time including the sound pressure and the particle velocity of the entire space up to late reverberation. Therefore, the calculation amount increases, and it is difficult to generate IR in real time and convolve the IR into a sound source in a game or the like. Here, the real time means that processing can be performed within 16 ms that can be obtained from, for example, the number of frames 60 fps often used in games.

Since the present disclosure focuses on the diffracted sound, it is sufficient that the simulation can be performed up to the time at which the diffracted sound can be observed. The time at which the diffracted sound can be observed can be calculated on the basis of the distance (path length) x of the diffraction path DR from the sound source S to the sound receiving point T. The diffraction path DR means a propagation path of the sound output from the sound source S to the sound receiving point T after being diffracted at the diffraction site DF. For example, the time t₀ of the diffracted sound observed first can be obtained by dividing the distance x by the sound speed c (t₀=x/c). Therefore, if simulation is performed up to a time of about t=2×t₀ seconds, a diffraction phenomenon including fine scattering and reflection components at the edge can be obtained.

The system developer can arbitrarily set how long the simulation time is set. For example, time until the diffracted sound first reaches the sound receiving point T can be calculated as arrival time (t₀) on the basis of the distance x of the diffraction path DR, and time equal to or more than 1 time and equal to or less than 5 times (preferably, equal to or less than 3 times) the arrival time can be set as the simulation time. Alternatively, since processing such as convolution of a sound source and IR is often calculated in the frequency domain using FFT, the simulation time can be set with the number of samples of a power of 2. For example, the simulation time can be set to the number of samples of 128 samples or more and 131072 samples or less. This value is about 2.7 milliseconds or more and 2.7 seconds or less in a case where the sampling rate is 48 kHz. In addition, the simulation time may be set by a method other than the method described above.

Therefore, IR in a certain space is simulated in advance up to a time step (about 2×t₀) at which a diffraction phenomenon can be observed, and IR of about 2×t₀ seconds is held as a table. As a result, only the processing of convolving the time signal of the sound source S and IR is performed, and it is possible to present a natural diffracted sound to the user U in real time. Hereinafter, the configuration of the acoustic processing apparatus 100 of the present disclosure and the acoustic processing method will be specifically described.

### 1-5. Configuration Example of Acoustic Processing Apparatus

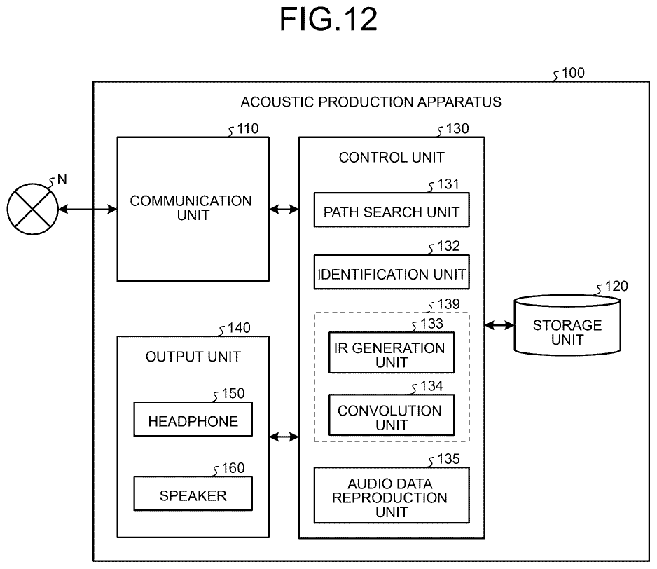

FIG. 12 is a diagram illustrating an example of a configuration of the acoustic processing apparatus 100.

The acoustic processing apparatus 100 includes a communication unit 110, a storage unit 120, a control unit 130, and an output unit 140. Note that the acoustic processing apparatus 100 may include input means (for example, a pointing device such as a touch panel, a keyboard, or a mouse, a voice input microphone, or an image input camera (line-of-sight or gesture input)) or the like that performs various operation inputs from the user U or the like who operates the acoustic processing apparatus 100.

The communication unit 110 is implemented by, for example, a network interface card (NIC) or the like. The communication unit 110 is connected to a network N (Internet, near field communication (NFC), Wi-Fi (registered trademark), Bluetooth (registered trademark), and the like) in a wired or wireless manner, and transmits and receives information to and from other information equipment and the like via the network N.

The storage unit 120 is implemented by, for example, a semiconductor memory element such as a random access memory (RAM) or a flash memory, or a storage apparatus such as a hard disk or an optical disk. The storage unit 120 stores various kinds of data such as audio data output from the sound source S, shape data of an object, a preset late reverberation sound setting, and a sound absorption coefficient setting.

The control unit 130 is implemented by, for example, a central processing unit (CPU), a micro processing unit (MPU), a digital signal processor (DSP), or the like executing a program (for example, the acoustic processing program according to the present disclosure) stored inside the acoustic processing apparatus 100 using a RAM or the like as a work area. Furthermore, the control unit 130 is a controller, and may be implemented by, for example, an integrated circuit such as an application specific integrated circuit (ASIC) or a field programmable gate array (FPGA).

The control unit 130 generates an audio signal according to the acoustic processing program and outputs the audio signal to the output unit 140. The output unit 140 includes a headphone 150 and a speaker 160. The output unit 140 outputs audio data to the user U via the headphones 150 and the speaker 160.

The control unit 130 includes a path search unit 131, an identification unit 132, a signal processing unit 139, and an audio data reproduction unit 135, and implements or executes functions and effects of information processing described below. Note that the internal configuration of the control unit 130 is not limited to the configuration illustrated in FIG. 12, and may be another configuration as long as information processing to be described later is performed.

### <1. Path Search Unit>

The path search unit 131 searches for the shortest path from the sound source S to the sound receiving point T. For example, the shortest path in FIG. 10 means a path through which the sound output from the sound source S is diffracted at the diffraction site DF and reaches the sound receiving point T. In FIG. 10, the shortest path is the same as the diffraction path DR. For example, the path search unit 131 searches for the shortest path on the basis of the spatial information, the object information, the sound source information, and the sound receiving point information acquired from the storage unit 120.

For example, the spatial information may include CAD data of the virtual space V arbitrarily created by a creator as illustrated in FIG. 1. The spatial information may include CAD data of the virtual space V in one scene of a certain game in which the user U is operating a character such as a game. The spatial information may include voxel data, mesh data, point cloud data, and the like in addition to the CAD data.

The object information includes, for example, information regarding the position, texture, material, size, density, internal sound speed, sound absorption coefficient, acoustic impedance, and the like of the object OB. The texture information includes information on the surface shape of the object OB. Here, the position may be expressed by a Cartesian coordinate system, a cylindrical coordinate system, or a spherical coordinate system.

The sound source information includes, for example, a position of the sound source S, a directional characteristic, time waveform data of the sound source S, a direction in which the sound source S is directed, and the like. The sound source information may include information regarding a sound type. In a case where the sound is a line, data of a character that emits the sound or metadata such as an angry voice or a laughing voice may be included in the sound source information. Here, a method of expressing the position of the sound source S may be a Cartesian coordinate system, a cylindrical coordinate system, or a spherical coordinate system.

The sound receiving point information includes, for example, a position of the sound receiving point T, directional characteristics, a direction in which the sound receiving point T (listener) faces, and a head related transfer function (HRTF) expressing characteristics from the sound source S to both ears of the listener. The position of the sound receiving point T may be expressed by a Cartesian coordinate system, a cylindrical coordinate system, or a spherical coordinate system.

As a method used for the path search, for example, a geometry-based method such as ray tracing is used. The path search unit 131 searches for the shortest path from the position of the sound source S to the position of the sound receiving point T, and outputs the searched path as path information.

### 2. Identification Unit

The identification unit 132 identifies a position (diffraction site DF) where diffraction occurs on the basis of the path information output from the path search unit 131. The identification unit 132 identifies whether an object is present on the path, that is, whether a diffraction site DF is present, from the input spatial information, object information, and path information. In a case where there is no diffraction site DF, a diffraction phenomenon does not occur, and thus, generation processing of a diffracted sound is not performed. In a case where there is the diffraction site DF, the shortest path including the diffraction site DF is the diffraction path DR, and the signal processing unit 139 performs the generation processing of the diffracted sound.

### 3. Signal Processing Unit

The signal processing unit 139 generates the diffracted sound acquired at the sound receiving point T on the basis of the wave acoustic simulation. Although the wave acoustic simulation can reproduce a real sound field, it is difficult to apply the wave acoustic simulation to a game or the like in which real-time properties are required due to a high calculation load. In the present disclosure, such a problem is improved by constraining time or space in which simulation is performed or both time and space. For example, the signal processing unit 139 generates the diffracted sound acquired at the sound receiving point T on the basis of the wave acoustic simulation in which the simulation time is constrained according to the distance of the diffraction path DR.

The signal processing unit 139 includes an IR generation unit 133 and a convolution unit 134. The IR generation unit 133 acquires an impulse response (IR) expressing propagation information of sound from the sound source S to the sound receiving point T. The convolution unit 134 convolves the IR acquired from the IR generation unit 133 with the time waveform data of the sound source S. As a result, the diffracted sound acquired at the sound receiving point T is generated.

For example, the storage unit 120 stores a table defining IR for each sound receiving point T. The IR is calculated in advance on the basis of the sound source information, the object information, and the sound receiving point information. For the calculation, a method such as FDTD, FEM, or BEM is used. The IR generation unit 133 detects the positional relationship among the sound source S, the sound receiving point T, and the diffraction site DF. The IR generation unit 133 reads IR data corresponding to the detected positional relationship from the table. The convolution unit 134 convolves the read IR with the time waveform data of the sound source S. The convolution unit 134 may further convolve the time signal expressing the HRTF in order to present a more realistic sound.

### 4. Audio Data Reproduction Unit

The audio data reproduction unit 135 reproduces a synthesized output sound obtained by synthesizing the diffracted sound generated by the convolution unit 134 and the early reflected sound, the transmitted sound, and the late reverberation sound generated in each step of FIG. 6 from reproduction equipment such as the headphones 150 or the speakers 160 used by the user U. As a result, a sound is presented to the user U.

### 1-6. Processing Flow Example 1

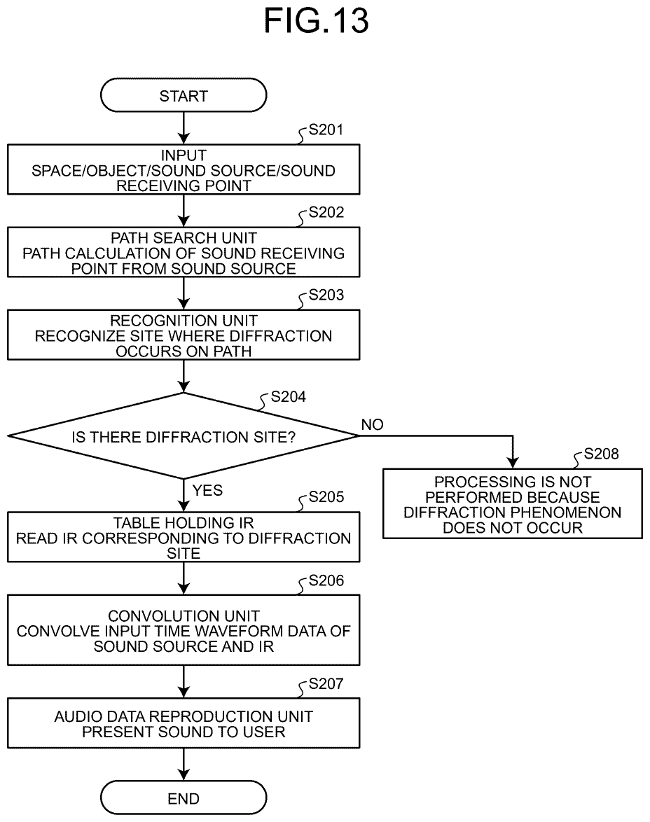

FIG. 13 is a diagram illustrating an example of a processing flow.

The acoustic processing apparatus 100 acquires spatial information, object information, sound source information, and sound receiving point information from an input apparatus (not illustrated) (step S201). The path search unit 131 outputs path information of the shortest path from the sound source S to the sound receiving point T using a geometry-based method such as ray tracing (step S202).

The identification unit 132 identifies a position (diffraction site DF) where diffraction occurs on the path on the basis of the path information output from the path search unit 131 (step S203). For example, the identification unit 132 identifies, from the input spatial information, object information, and path information, whether an object OB exists on the path, that is, whether a diffraction site DF exists (step S204). In a case where there is no diffraction site DF (step S204: No), the diffraction phenomenon does not occur, and thus the present processing ends (step S208).

In a case where there is the diffraction site DF (step S204: Yes), the path including the diffraction site DF becomes the diffraction path DR, and the IR generation unit 133 reads the corresponding IR from the table holding the IR calculated in advance using the FDTD, the FEM, or the BEM (step S205). The convolution unit 134 convolves the read IR with the time waveform data of the sound source S to generate a diffracted sound (step S206). The convolution unit 134 can further convolve the time signal expressing the HRTF in order to present a realistic sound to the user U.

The audio data reproduction unit 135 reproduces the synthesized output sound including the diffracted sound generated by the convolution unit 134 using reproduction equipment such as the headphones 150 or the speakers 160 used by the user U (step S207). As a result, a sound is presented to the user U. Note that the reproduction equipment is not limited to the above example, and may be an earphone, a head mounted display (HMD), or the like.

### 1-7. Processing Flow Example 2

In the processing flow example 1 described above, a table holding IR is used for the IR generation processing. In this method, since the table needs to hold IR data expressing diffraction phenomena for various objects OB, the amount of data becomes enormous. Therefore, a method of generating an IR using an AI model learned in advance instead of a table is also conceivable.

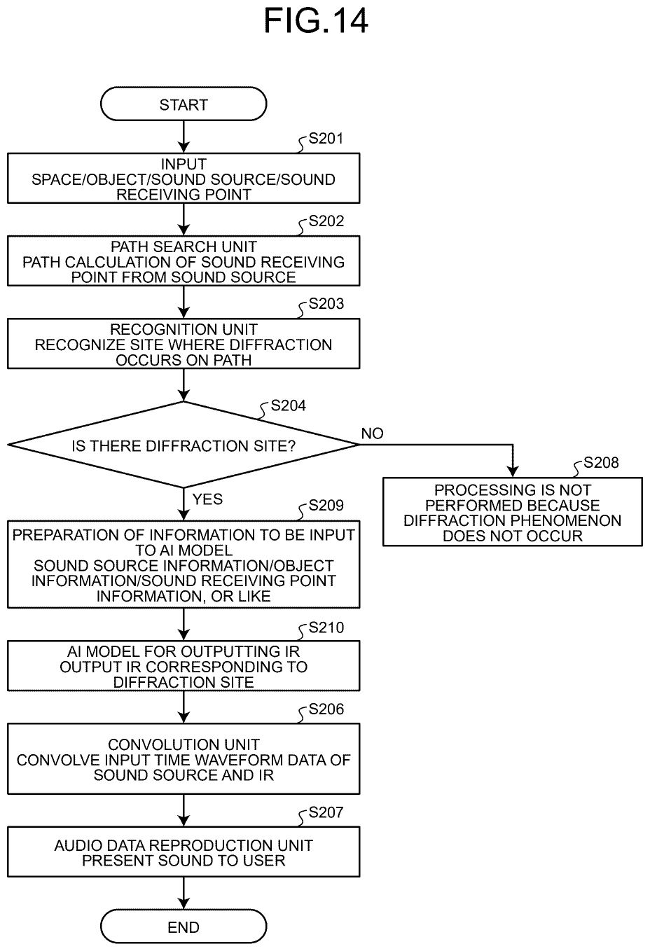

FIG. 14 is a diagram illustrating an example of a processing flow using an AI model. The difference from the processing flow example 1 is that the IR generation unit 133 generates an IR using an AI model (step S209 and step S210).

The AI model is a learned neural network in which a relationship between a simulation condition of the wave acoustic simulation and a simulation result obtained in the simulation condition is learned as a relationship between input data and correct answer data.

For example, the AI model can be a model in which IR is output when sound source position information, object information, sound receiving point information, angle information from the sound source S to an edge (diffraction site DF) of the object OB, angle information from the edge to the sound receiving point T, and the like are input. The angle information (incident angle information) from the sound source S to the edge and the angle information (emission angle information) from the edge to the sound receiving point T can be calculated, for example, on the basis of the path information output from the path search unit 131 and the information of the diffraction site DF output from the identification unit 132.

The AI model may be a Physics-Informed Neural Networks (PINNs) model incorporating physical information such as a wave equation. For PINNs, refer to “Physics-Informed Neural Networks: A Deep Learning Framework for Solving Forward and Inverse Problems Involving Nonlinear Partial Differential Equations, M. Raissi, P. Perdikaris, G. E. Karniadakis, 2019”.

The IR generation unit 133 prepares sound source information, object information, sound receiving point information, and the like to be input information (step S209). The IR generation unit 133 calculates the incident angle information and the emission angle information on the basis of the path information and the information of the diffraction site DF. The IR generation unit 133 inputs the input information, the incident angle information, and the emission angle information to the AI model, and outputs IR corresponding to the diffraction site DF (step S210). Steps other than steps S209 and S210 are similar to those in the processing flow example 1.

Note that, in the processing flow example 1 and the processing flow example 2, IR corresponding to a scene is generated using IR calculated in advance. This method is effective in a case where it is difficult to sequentially perform enormous calculation necessary for simulation. However, in a case where various operations can be processed in real time due to development of calculation resources, a table holding IR and an AI model are not necessarily required. In this case, the IR may be generated by inputting the spatial information, the object information, the sound source information, and the sound receiving point information of the virtual space V for each scene and directly executing the wave acoustic-based simulation.

In order to save calculation resources, it is preferable to constrain the simulation time according to the distance of the diffraction path DR. For example, the IR generation unit 133 calculates the time until the diffracted sound first reaches the sound receiving point T as the arrival time t₀ on the basis of the distance of the diffraction path DR. The IR generation unit 133 sets, for example, a time equal to or more than 1 time and equal to or less than 5 times the arrival time t₀ as the simulation time. Alternatively, since processing such as convolution of a sound source and IR is often calculated in the frequency domain using FFT, the simulation time can be set with the number of samples of a power of 2. For example, the simulation time can be set to the number of samples of 128 samples or more and 131072 samples or less. This value is about 2.7 milliseconds or more and 2.7 seconds or less in a case where the sampling rate is 48 kHz.

### 1-8. Processing Flow Example 3

The three patterns of the “table holding IR”, the “AI model outputting IR”, and the “direct use of wave acoustic simulation” have been described above. In a case where a game or the like is considered, it is necessary to secure a table holding IR, an AI model, and a memory for a wave acoustic simulation algorithm on a CPU or a GPU. In the case of reducing the memory, it is conceivable to process some or all of the necessary operations in the cloud.

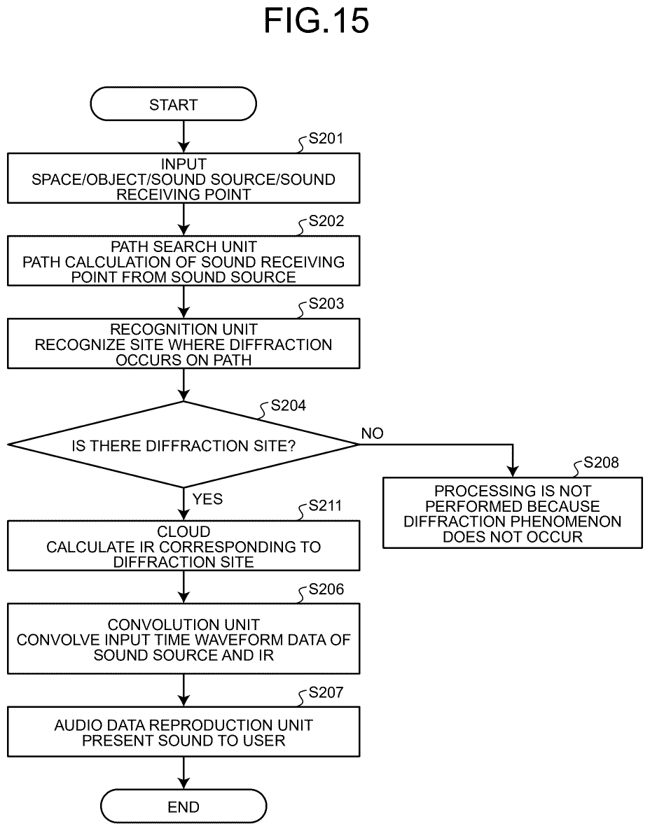

FIG. 15 is a diagram illustrating an example of a processing flow using a cloud. The difference from the processing flow example 1 and the processing flow example 2 is that IR is generated using a cloud (step S211).

In this method, a table holding IR, an AI model, or an algorithm such as FDTD of wave acoustic simulation is held in a server on a cloud. The server acquires the sound source information, the object information, the sound receiving point information, and the path information from a terminal (client terminal) such as a game machine serving as a client, and calculates IR corresponding to the diffraction position (step S211). The client terminal performs a convolution operation on the time waveform data of the IR and the sound source S acquired from the server, and presents a sound to the user U. Steps other than step S211 are similar to those in the processing flow example 1.

In the example of FIG. 15, only the calculation of IR is performed by the server, and the convolution operation is performed by the client terminal. However, both IR calculation and convolution operation may be performed by the server. In this case, the client terminal passes the time waveform data of the sound source S to the server together with the sound source information, the object information, the sound receiving point information, and the path information. The server performs a convolution operation on the time waveform data of the corresponding IR and the sound source S to generate a diffracted sound, and transmits the diffracted sound to the client terminal.

In this method, the client terminal only needs to perform processing of presenting sound to the user U. Therefore, the calculation amount of the client terminal can be reduced. In a case where the communication between the client terminal and the server is performed at a high speed at a level at which a sense of discomfort does not occur during the play of the game, the above-described method can be implemented.

### 2. Second Embodiment: Constraint on Simulation Space

In general, in the FDTD or the like, the entire space is discretized, and calculation is sequentially performed at each time step up to a certain time including the sound pressure and the particle velocity of the entire space up to late reverberation. Therefore, the calculation amount increases. In the first embodiment, the simulation time is constrained according to the distance of the diffraction path DR by focusing on the fact that it is only necessary to perform simulation up to the time at which the diffracted sound can be observed. In the second embodiment, simulation is performed only in a subspace in which a diffraction phenomenon occurs without discretizing the entire space.

### 2-1. Features of Audio Signal Generation Processing of Second Embodiment

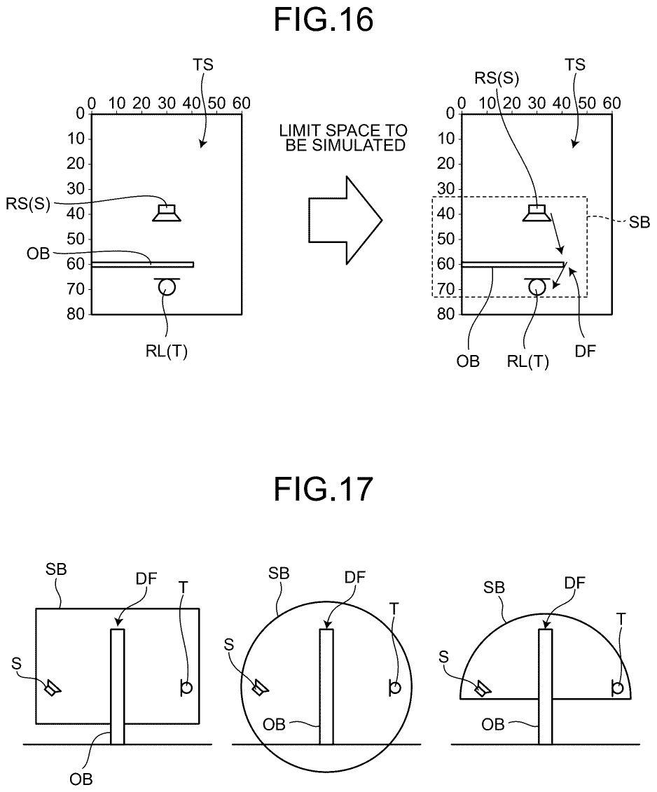

FIG. 16 is a diagram for explaining features of the audio signal generation processing of the second embodiment.

The present embodiment is different from the first embodiment in that the space for performing the wave acoustic simulation is limited to the periphery of the diffraction site DF. The IR generation unit 133 acquires the diffraction site DF on the object OB where the diffraction phenomenon occurs. The IR generation unit 133 generates IR in the subspace SB by selectively performing wave acoustic simulation on the subspace SB including the diffraction site DF.

In general wave acoustic simulation, since the entire region (entire space TS) of the virtual space V is simulated, a calculation load is high (see the left diagram in FIG. 16). In the present embodiment, a small space around the diffraction site DF in the entire space TS is set as the subspace SB to be simulated. For example, the storage unit 120 stores the size of the virtual space V that can be simulated in one frame period. The IR generation unit 133 acquires a size that can be simulated in one frame period as a maximum size from the storage unit 120. The IR generation unit 133 sets the subspace SB as a space having a size equal to or smaller than the maximum size.

For example, the subspace SB is set as a space including at least one of the sound source S or the sound receiving point T. As an example, the subspace SB is set as a space including at least one of the sound source S or the sound receiving point T on the boundary with the external space (the virtual space V outside the subspace SB). The sound source S may be an actual sound source (real sound source RS) that is a sound generation source, or may be a virtual sound source VS (see FIG. 23) set on the diffraction path DR between the real sound source RS and the diffraction site DF. The sound receiving point T may be an actual sound receiving point (real sound receiving point RL) to be a sound listening position (for example, the position of the ear of the user U), or may be a virtual sound receiving point VL (see FIG. 23) set on the diffraction path DR between the real sound receiving point RL and the diffraction site DF. In the example of FIG. 16, the subspace SB is set as a small space including the real sound source RS, the diffraction site DF, and the real sound receiving point RL.

In a case where the real sound source RS, the diffraction site DF, and the real sound receiving point RL are arranged at positions sufficiently close to the extent that the real-time simulation can be performed, it is needless to say that the subspace SB can be configured as a space that internally includes the real sound source RS, the diffraction site DF, and the real sound receiving point RL (a configuration in which both the real sound source RS and the real sound receiving point RL are not on the boundary of the subspace SB).

### 2-2. Configuration Example of Subspace

FIG. 17 is a diagram illustrating a configuration example of the subspace SB.

The identification unit 132 specifies the diffraction site DF on the basis of the path information acquired from the path search unit 131, and determines the subspace SB to be input to the IR generation unit 133. The subspace SB may be a space defined in advance, or may be set by a creator such as a sound designer who actually produces sound of a game or the like.

In the example of FIG. 17, the subspace SB is set to include a part or all of the object OB including the diffraction site DF, and the sound source S and the sound receiving point T. For example, in a case of considering a two-dimensional space, the subspace SB can be set as a square, a rectangle, a circle, or a semicircle. In a case of considering a three-dimensional space, the subspace SB can be set as a cube, a rectangular parallelepiped, a sphere, or a hemisphere. The above-described shape is an example, and the subspace SB can be set to various shapes other than the above-described example.

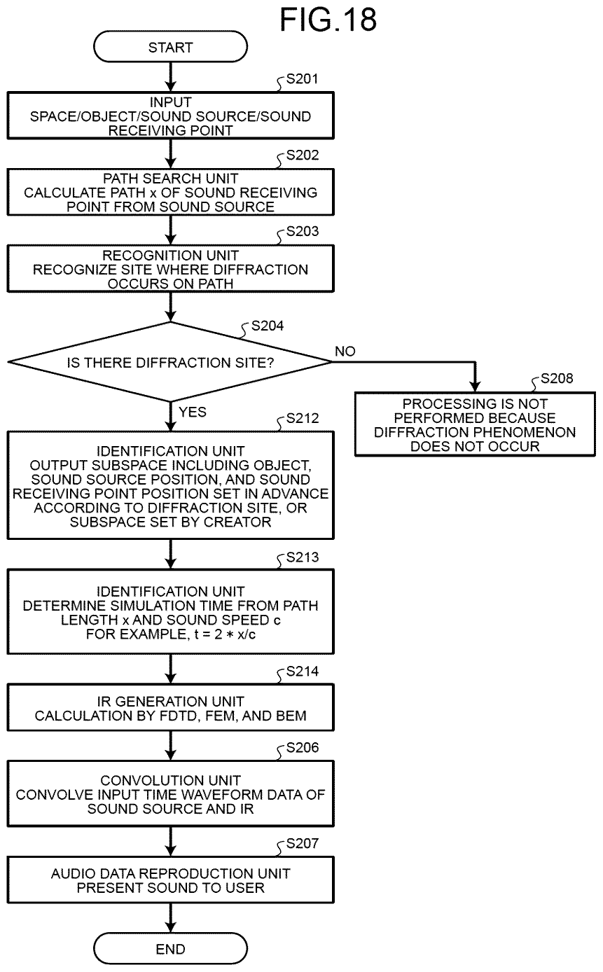

FIG. 18 is a diagram illustrating an example of a processing flow. Differences from the first embodiment are setting processing of the subspace SB (step S212), setting processing of the simulation time (step S213), and generation processing of IR (step S214).

The identification unit 132 sets a subspace SB including the sound source S, the diffraction site DF, and the sound receiving point T (step S212). The subspace SB may be defined in advance according to the diffraction site DF, or may be arbitrarily defined by the creator. The identification unit 132 determines a simulation time on the basis of the distance of the diffraction path DR (step S213). For example, the simulation time t is set to t=2×x/c using the distance x of the diffraction path DR and the sound speed c.

The IR generation unit 133 receives information of the subspace SB in which the simulation is performed, information of the time t at which the diffraction phenomenon is simulated, sound source information, sound receiving point information, and object information. The IR generation unit 133 executes the wave acoustic simulation on the basis of the received information and generates IR (step S214). As a simulation method, methods such as FDTD, FEM, and BEM are used.

Note that the IR generation processing may be performed using an AI model that inputs object information, sound source information, and sound receiving point information and outputs IR. The AI model may be the PINNs model described above. The IR generation processing may be performed on a cloud.

### 2-3. Relationship Between Real Sound Source and Real Sound Receiving Point and Subspace

In the example of FIG. 16, the subspace SB is set as a small space including the real sound source RS and the real sound receiving point RL. However, the subspace SB may be set as a small space that does not include one or both of the real sound source RS and the real sound receiving point RL.

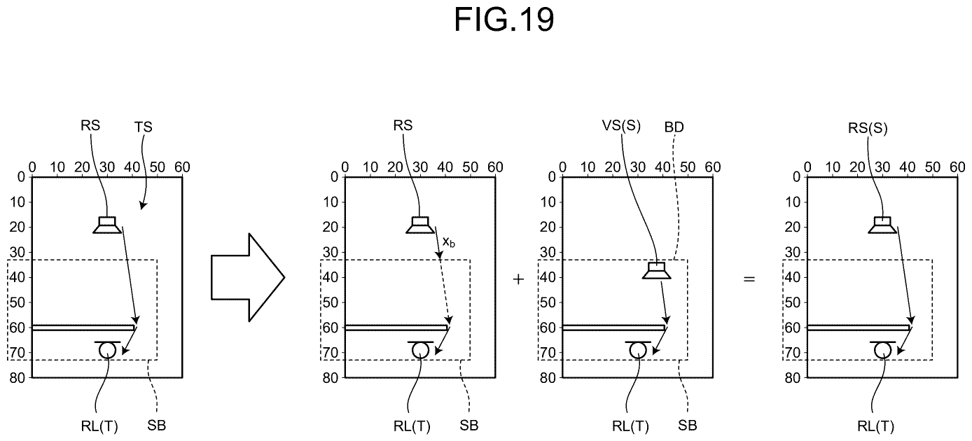

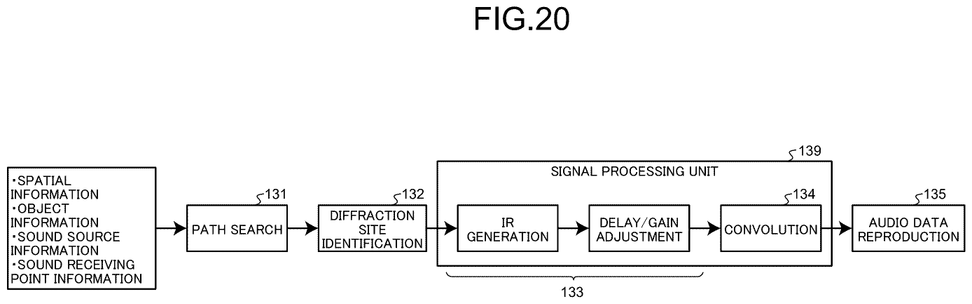

FIG. 19 is a diagram for explaining a processing example in a case where the real sound source RS is not included in the subspace SB. FIG. 20 is a block diagram illustrating a flow of generation processing of diffracted sound. FIG. 20 is different from the first embodiment in that the IR generation unit 133 performs delay/gain adjustment of IR.

### 2-4. Delay/Gain Adjustment

In a case where the subspace SB does not include the real sound source RS, the identification unit 132 sets a point on the boundary of the subspace SB intersecting the diffraction path DR as the virtual sound source VS. The identification unit 132 calculates the distance between the real sound source RS and the virtual sound source VS as the attenuation distance x_{b}. The identification unit 132 calculates the delay time τ according to the attenuation distance x_{b} using the sound speed c (τ=x_{b}/c). The identification unit 132 calculates an amplitude attenuation rate according to the attenuation distance x_{b}. For the calculation of the amplitude attenuation rate, an inverse square law such as “attenuation of −6 dB is obtained when the distance is doubled” or an attenuation curve uniquely set by the creator may be used.

The IR generation unit 133 sets the virtual sound source VS and the real sound receiving point RL as the sound source S and the sound receiving point T of the wave acoustic simulation. The IR generation unit 133 performs wave acoustic simulation on the subspace SB and generates IR between the sound source S and the sound receiving point T. The IR generation processing has a temporal constraint similar to that of the first embodiment. The simulation time is constrained according to the distance of the diffraction path DR from the sound source S (virtual sound source VS) to the sound receiving point T (real sound receiving point RL). For example, the simulation time t is calculated as τ=2×(x−x_{b})/c using the distance (x−x_{b}) obtained by subtracting the attenuation distance x_{b} from the distance x of the diffraction path DR and the sound speed c. The IR generation unit 133 adds the amplitude attenuation rate and the delay time τ according to the attenuation distance x_{b} to IR.

Note that it is assumed that the IR obtained by the wave acoustic simulation is normalized such that the absolute value of the maximum amplitude is 1 or the maximum value of the data type of the sound pressure holding. The normalization coefficient used here may be held in a memory as data. Then, an IR obtained by adding the delay time τ to the normalized IR and further multiplying the IR by the amplitude attenuation rate is an IR that is originally desired to be obtained.

The above idea can be similarly applied when the real sound receiving point RL is set outside the subspace SB. For example, in a case where the subspace SB does not include the real sound receiving point RL, the identification unit 132 sets a point on the boundary of the subspace SB intersecting the diffraction path DR as the virtual sound receiving point VL. The IR generation unit 133 adds, to IR, the amplitude attenuation rate and the delay time τ according to the attenuation distance x_{b} between the real sound receiving point RL and the virtual sound receiving point VL.

In the above-described method, the subspace SB in which simulation is to be performed is further reduced. Therefore, the calculation amount is reduced, and real-time voice processing is easily performed.

### 2-5. Processing Flow Example

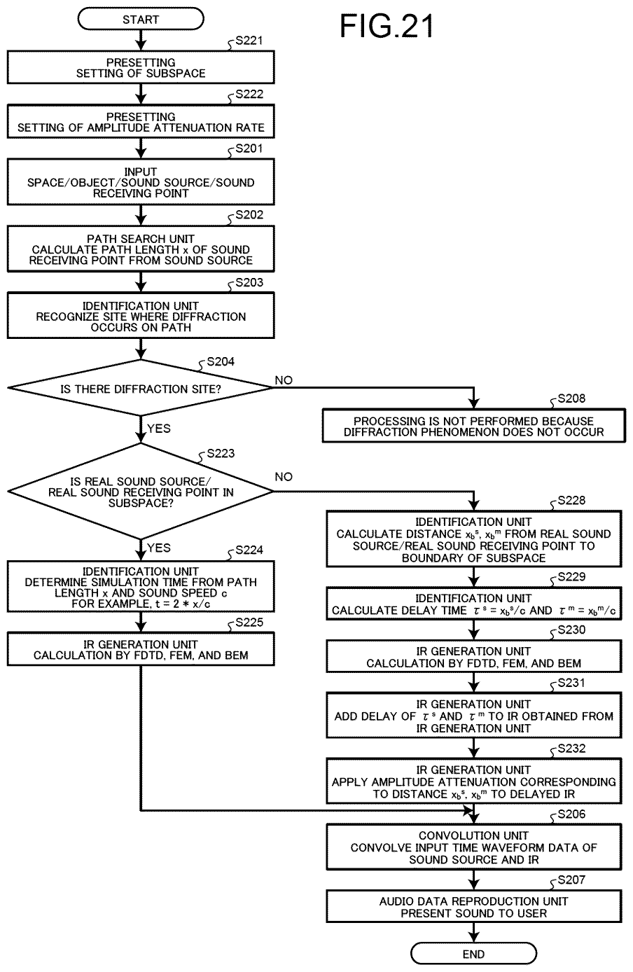

FIG. 21 is a diagram illustrating an example of a processing flow. Differences from the first embodiment are presetting processing (steps S221 to S222) and IR generation/delay addition/gain adjustment processing (steps S231 to S232).

In this flow, setting regarding the subspace SB and the amplitude attenuation rate is performed as presetting. The storage unit 120 stores setting information regarding the subspace SB and the amplitude attenuation rate. The identification unit 132 performs setting regarding the shape and size of the subspace SB on the basis of the setting information acquired from the storage unit 120 (step S221). The IR generation unit 133 makes settings related to the method of calculating the amplitude attenuation rate on the basis of the setting information acquired from the storage unit 120 (step S222).

Thereafter, the diffraction site DF is detected using a method similar to that of the first embodiment (steps S201 to S204). The identification unit 132 extracts a small space having a shape and a size according to the setting information from the entire space TS with the diffraction site DF as a center. The identification unit 132 sets the extracted small space as a subspace SB to be a target of the wave acoustic simulation. The identification unit 132 determines whether or not the real sound source RS and the real sound receiving point RL exist in the subspace SB (step S223).

In a case where the real sound source RS and the real sound receiving point RL exist in the subspace SB (step S223: Yes), the identification unit 132 sets the real sound source RS and the real sound receiving point RL as they are as the sound source S and the sound receiving point T in the wave acoustic simulation.

The identification unit 132 determines the simulation time t using the distance x of the diffraction path DR and the sound speed c (τ=2×x/c) (step S224). The IR generation unit 133 performs a wave acoustic simulation such as FTDT, FEM, or BEM on the subspace SB to generate IR (step S225). The convolution unit 134 convolves the time waveform data of the real sound source RS and IR to generate a diffracted sound (step S206). The audio data reproduction unit 135 presents the synthesized output sound including the generated diffracted sound to the user U via the headphones 150 and the speaker 160 (step S207).

In a case where the real sound source RS and the real sound receiving point RL do not exist in the subspace SB (step S223: No), the identification unit 132 sets a virtual sound source (virtual sound source VS) or a virtual sound receiving point (virtual sound receiving point VL) on the boundary of the subspace SB. For example, in a case where the real sound source RS does not exist in the subspace SB, the identification unit 132 sets the virtual sound source VS on the diffraction path DR between the real sound receiving point RL and the diffraction site DF. The identification unit 132 sets the virtual sound source VS as the sound source S in the wave acoustic simulation. In a case where the real sound receiving point RL does not exist in the subspace SB, the identification unit 132 sets the virtual sound receiving point VL on the diffraction path DR between the real sound receiving point RL and the diffraction site DF. The identification unit 132 sets the virtual sound receiving point VL as a sound receiving point T in the wave acoustic simulation.

The identification unit 132 calculates a distance from the real sound source RS or the real sound receiving point RL not present in the subspace SB to the boundary of the subspace SB as the attenuation distance x_{b} (step S228). For example, in a case where the real sound source RS does not exist in the subspace SB, the identification unit 132 calculates the distance from the real sound source RS to the boundary (virtual sound source VS) of the subspace SB as the attenuation distance x_{b}^{s}. In a case where the real sound receiving point RL does not exist in the subspace SB, the identification unit 132 calculates the distance from the real sound receiving point RL to the boundary (virtual sound receiving point VL) of the subspace SB as the attenuation distance x_{b}^{m}.

The identification unit 132 calculates the delay time τ according to the attenuation distance x_{b} (step S229). For example, in a case where the real sound source RS does not exist in the subspace SB, the identification unit 132 calculates a value obtained by dividing the attenuation distance x_{b}^{s} by the sound speed c as the delay time τ^{s}. In a case where the real sound receiving point RL does not exist in the subspace SB, the identification unit 132 calculates a value obtained by dividing the attenuation distance x_{b}^{m} by the sound speed c as the delay time τ^{m}. In a case where both the real sound source RS and the real sound receiving point RL do not exist in the subspace SB, the delay time is τ^{s}+τ^{m}, and the distance to consider the amplitude attenuation is x_{b}^{s}+x_{b}^{m}.

The IR generation unit 133 performs a wave acoustic simulation such as FTDT, FEM, or BEM on the subspace SB to generate IR (step S230). The IR generation unit 133 adds the delay time τ to the generated IR (step S231). Furthermore, the IR generation unit 133 adds an amplitude attenuation rate (gain) corresponding to the attenuation distance x_{b} to the generated IR (step S232). The convolution unit 134 convolves the time waveform data of the real sound source RS and IR to which the delay time τ and the amplitude attenuation rate are applied, and generates a diffracted sound (step S206). The audio data reproduction unit 135 presents the synthesized output sound including the generated diffracted sound to the user U via the headphones 150 and the speaker 160 (step S207).

Note that the order of addition of the delay time τ and addition of the amplitude attenuation rate (gain adjustment) may be changed. In the above flow, a preset amplitude attenuation rate is applied for gain adjustment. However, when a creator wants to exaggerate a sound from a certain sound source, it is also possible to adjust a gain parameter and reflect an adjustment result in the sound.

### 2-6. Circular/Spherical Subspace

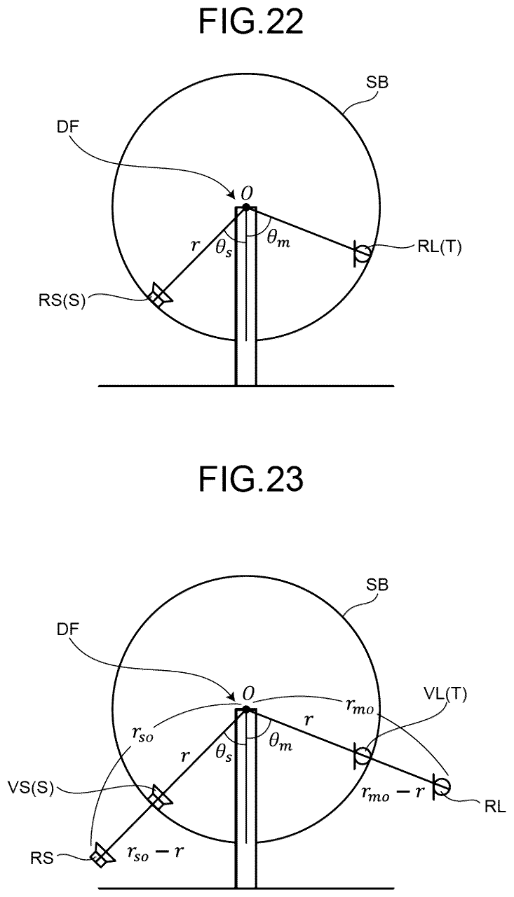

FIG. 22 is a diagram illustrating an example in which the subspace SB is configured as a spherical or circular space centered on the diffraction site DF. In FIG. 22, since the subspace SB is illustrated as a two-dimensional plane, the subspace SB is a circle represented by a polar coordinate system (r, θ), but in the case of a three-dimensional space, the subspace SB is a sphere represented by a spherical coordinate system (r, θ, φ).

The identification unit 132 specifies an edge of the object OB to be the diffraction site DF, and sets a circle having a radius r from the center O of the edge. The IR generation unit 133 simulates IR from the sound source S on the circumference to the sound receiving point T by FDTD or the like, and can obtain IR by adjusting the delay and the gain using the above-described method.

As an advantage of the circular or spherical subspace SB, since the distance (=r) from the sound source S or the sound receiving point T on the subspace SB to the center O of the edge is constant, the delay time τ can be easily obtained. Furthermore, by making the subspace SB circular, it is also possible to calculate angle information of the incident angle θₛ from the sound source S to the edge and the angle θₘ from the edge to the sound receiving point T. In a case where a three-dimensional space is considered (θₛ, φₛ), there is a pair of the horizontal angle θ and the elevation angle φ of (θₘ, φₘ). The angle information obtained here can also be used as input information at the time of performing numerical simulation such as FDTD, can also be used as input data in the case of adopting an AI model, and can also be used as table information at the time of creating a table holding IR.

FIG. 23 is a diagram illustrating an example in which the real sound source RS and the real sound receiving point RL are outside the subspace SB.

The distance r_{sO} from the real sound source RS to the center O of the edge is calculated on the basis of the sound source information and the position information of the diffraction site DF. The distance r_{mO} from the real sound receiving point RL to the center O of the edge is calculated on the basis of the sound receiving point information and the position information of the diffraction site DF. The radius of the subspace SB is set as r. Therefore, the distance from the real sound source RS to the virtual sound source VS is r_{sO}−r. The distance from the real sound receiving point RL to the virtual sound receiving point VL is r_{mO}−r. By dividing these distances by the sound speed c, the delay time τ can be easily obtained. Then, if the calculated delay time τ is added to IR, a correct IR delay time can be obtained.

In the example of FIG. 23, a case where the real sound source RS and the real sound receiving point RL are present outside the subspace SB has been considered. However, a similar idea can be applied to a case where the real sound source RS and the real sound receiving point RL are present inside the subspace SB. In this case, since the radius r is larger, the delay time t₀ be adjusted is a value obtained by adding (r−r_{sO})/c and (r−r_{mO})/c. Then, the IR having the correct delay time can be obtained by cutting the head signal of the IR obtained by the simulation such as the FDTD by the calculated delay time.

### 2-7. Setting Example of Size of Subspace

The size (radius r) of the subspace SB can be set as follows. For example, the frame rate often employed in games is 60 fps. The game machine performs some processing every 16 ms. Therefore, it is conceivable to determine the radius r from a frame period of 16 ms.

It is assumed that the virtual sound source VS and the virtual sound receiving point VL are arranged on the circumference of the radius r. In this case, the diffraction path DR from the virtual sound source VS to the virtual sound receiving point VL is 2×r. Using the sound speed c, the arrival time t₀ is t₀=2×r/c. As described above, it is considered that the simulation time t needs to be about τ=2×t₀ seconds. When a numerical value of 16 ms is used, 4×r/c=16 ms is obtained, and when c=340 m/s, r=1.36 m is obtained. In this way, even if the large-scale virtual space V is given, it is sufficient that only a space of a circle or a sphere having a radius of 1.36 m can be simulated around each diffraction site DF calculated by the identification unit 132.

The identification unit 132 may set the size of the subspace SB on the basis of the size of the object OB in which the diffraction phenomenon occurs. For example, the identification unit 132 can set the subspace SB as a space including the surface area or the volume of the object OB by a preset ratio. For example, if 50% or more of the surface area or volume of each object OB can be covered, the outline of the object OB can be known. Therefore, it is also conceivable to set the subspace SB with a circle or a sphere having a radius depending on the size of each object OB using a numerical value of 50% or more as an index. In this case, since the subspace SB corresponding to the large object OB becomes large, there is a disadvantage that the calculation load increases.

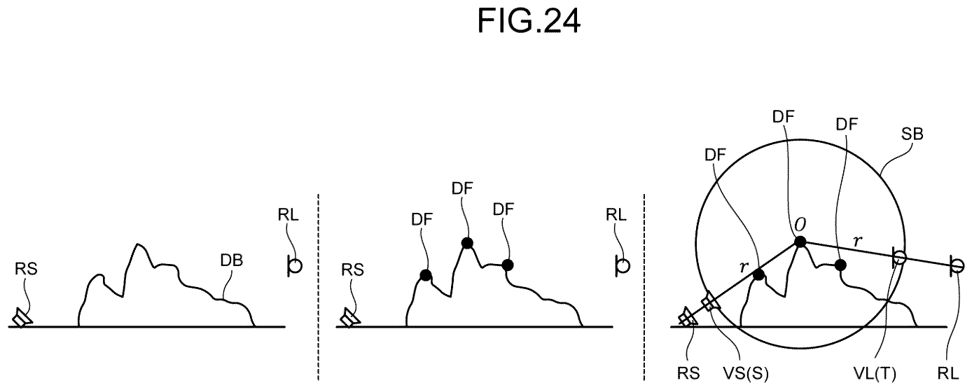

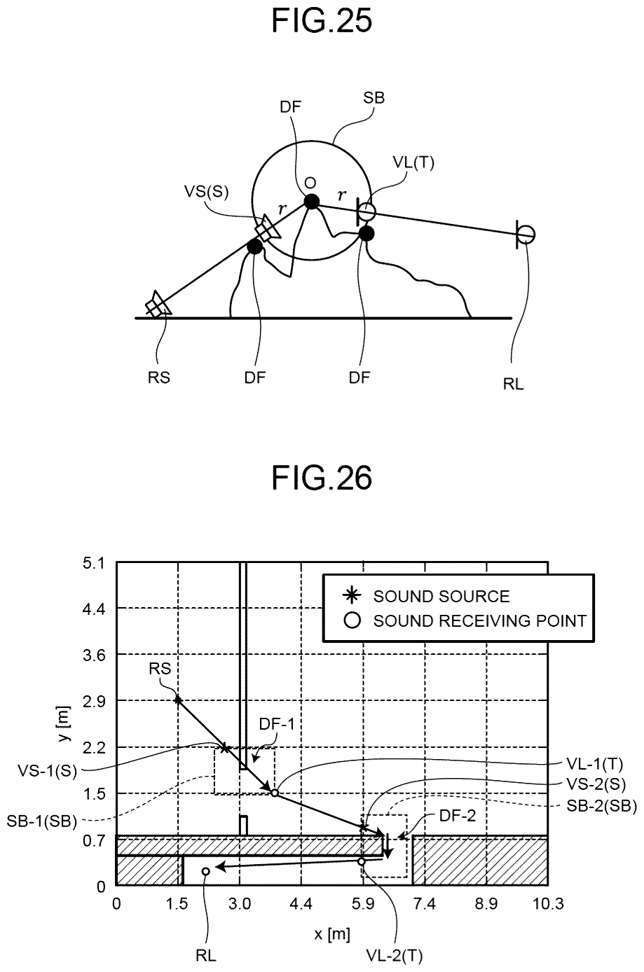

A complex object OB having a plurality of diffraction sites DF can be handled as follows. FIGS. 24 and 25 are diagrams for explaining an example of a method of setting the subspace SB for a complex object OB.

In the example of FIG. 24, a plurality of diffraction sites DF is present in the same object OB. The identification unit 132 sets the subspace SB so as to include all the plurality of diffraction sites DF. However, in a case where the object OB is large, the subspace SB also increases, and the calculation load increases. Therefore, it is also conceivable to perform the wave acoustic simulation only in the subspace SB in which the radius r is set to a fixed value of a certain value in advance. FIG. 25 illustrates a state at that time.

The identification unit 132 extracts one or more diffraction sites DF that can be included in the subspace SB from a plurality of diffraction sites DF included in the same object OB. The IR generation unit 133 selectively performs the wave acoustic simulation on the extracted one or more diffraction sites DF. For example, in a case where the subspace SB as illustrated in FIG. 25 is set, only the diffraction phenomenon occurring at the diffraction site DF located at the center among the plurality of diffraction sites DF is simulated. Alternatively, only the diffraction phenomenon occurring at the diffraction site DF corresponding to the peak value among the plurality of diffraction sites DF is simulated. The peak value in FIG. 25 refers to the diffraction site DF at the center on the uppermost side when the three diffraction sites DF are connected by a straight line. The diffraction phenomenon of the other diffraction site DF occurring in the original diffraction path DR is not simulated. However, such a way of thinking is also possible in a case where there is no sense of discomfort in audibility with respect to the generated diffracted sound.

### 3. Third Embodiment: Generation of High-Order Diffracted Sound Based on Combination of Plurality of Subspaces

FIG. 26 is a diagram for explaining features of audio signal generation processing of the third embodiment.

In the first embodiment and the second embodiment, an example in which there is only one object OB in the diffraction path DR from the sound source S to the sound receiving point T, that is, an example in which diffraction occurs only once has been described. In the third embodiment, a case where a plurality of diffraction sites DF is present in the diffraction path DR from the sound source S to the sound receiving point T will be described. The plurality of diffraction sites DF is detected by the identification unit 132.

Hereinafter, in a case of distinguishing the plurality of diffraction sites DF, an identification number is attached after the reference sign. It similarly applies to the case of distinguishing between the subspaces SB, between the virtual sound sources VS, and between the virtual sound receiving points VL. The diffraction site DF, the virtual sound source VS, and the virtual sound receiving point VL belonging to the same subspace SB are assigned the same identification numbers as those of the subspace SB.

The identification unit 132 detects a plurality of diffraction sites DF that diffracts the sound output from the sound source S toward the sound receiving point T. The identification unit 132 classifies the detected diffraction sites DF into a plurality of groups on the basis of the maximum size described above. The identification unit 132 sets the subspace SB for each of the classified groups. The IR generation unit 133 adds an amplitude attenuation rate and a delay time according to the distance between the subspaces SB along the diffraction path DR to IR.

FIG. 26 illustrates an example in which there are two diffraction sites DF. The identification unit 132 sets the subspace SB for each diffraction site DF. In the example of FIG. 26, the subspace SB is secured as a rectangle, but the subspace SB may be a closed space other than a rectangle such as a circle.

When the plurality of subspaces SB is secured by the identification unit 132, the IR generation unit 133 assumes that the virtual sound source VS-1 and the virtual sound receiving point VL-1 are on the boundary of the subspace SB-1, inputs the Gaussian pulse from the virtual sound source VS-1, and obtains IR expressing the diffraction phenomenon by a method such as FDTD. Here, other signals such as time stretched pulse (TSP) may be used as long as IR can be simulated in addition to the Gaussian pulse.

If the method for obtaining IR is the learned AI model, the model is such that the input is the angle information from the virtual sound source VS to the edge (diffraction site DF), the object information, and the angle information from the edge to the virtual sound receiving point VL, and the output is IR. Alternatively, an input similar to that of the learned AI model may be given, and IR may be obtained from a table held by simulating IR in advance.

The IR generation unit 133 inputs the IR obtained in the subspace SB-i to the virtual sound source VS-2, and obtains the IR up to the virtual sound receiving point VL-2 using the FDTD, the AI model, or the table. The IR generation unit 133 acquires a distance on the diffraction path DR from the real sound source RS to the subspace SB-1, a distance on the diffraction path DR from the subspace SB-1 to the subspace SB-2, and a distance on the diffraction path DR from the subspace SB-2 to the real sound receiving point RL as attenuation distances, and adds the delay time τ and the amplitude attenuation rate according to the attenuation distance to IR. As a result, IR expressing the diffracted sound in a case where there are two diffraction sites DF can be obtained by low calculation. In addition, similarly, for the virtual sound source VS-2, a method is also possible which input a Gaussian pulse, obtain the IR up to the virtual sound receiving point VL-2 using the FDTD, the AI model, or the table, and perform a convolution operation with the IR obtained in the subspace SB-1. In this case, IR calculation of each of the subspace SB-i and the subspace SB-2 can be processed in parallel. The method of adding the delay time τ and the amplitude attenuation rate according to the attenuation distance to IR is similar. These concepts are similar even when the number of diffraction sites DF is three or more.

On the other hand, as the number of diffraction sites DF increases, the amplitude of IR expressing the diffracted sound decreases. Therefore, it is also possible to set a threshold value for the amplitude of IR and not to calculate the diffracted sound in a situation where the amplitude is equal to or less than the threshold value. Since the magnitude of the amplitude depends on the distance (path length) of the diffraction path DR from the real sound source RS to the real sound receiving point RL, the necessity of the calculation may be determined by setting a threshold value to the path length. For example, the signal processing unit 139 can constrain the generation of the diffracted sound passing through the diffraction path DR having a length exceeding a preset allowable length. The constraint includes, for example, partial or total prohibition. The allowable length can be arbitrarily set. In a case where a threshold value is set for the path length, it is determined whether or not calculation is necessary without calculating IR. Therefore, the load of calculation is reduced.

Alternatively, it is also possible to set a threshold value for the number of diffraction sites DF and determine whether calculation is necessary. For example, the signal processing unit 139 can constrain the generation of the diffracted sound passing through the number of subspaces SB exceeding a preset allowable number. The allowable number can be arbitrarily set. For example, in a case where there are three or more diffraction sites DF, a method is conceivable where calculation is not performed or the like. Also in this method, since the necessity of the calculation is easily determined, the load of the calculation is reduced.

### 4. Modification 1: Constraint on Audio Signal Generation Processing Based on Directivity of Sound Source

Although the directivity of the sound source S has not been mentioned so far, the generation processing of the diffracted sound is unnecessary in the direction in which the sound source S has the directivity and the sound is not strongly emitted. Therefore, the signal processing unit 139 can acquire the allowable propagation direction in which the propagation of the sound is allowed on the basis of the directivity of the sound source S, and can constrain the generation of the diffracted sound propagating in a direction other than the allowable propagation direction. Information regarding the directivity of the sound source S is included in the sound source information.

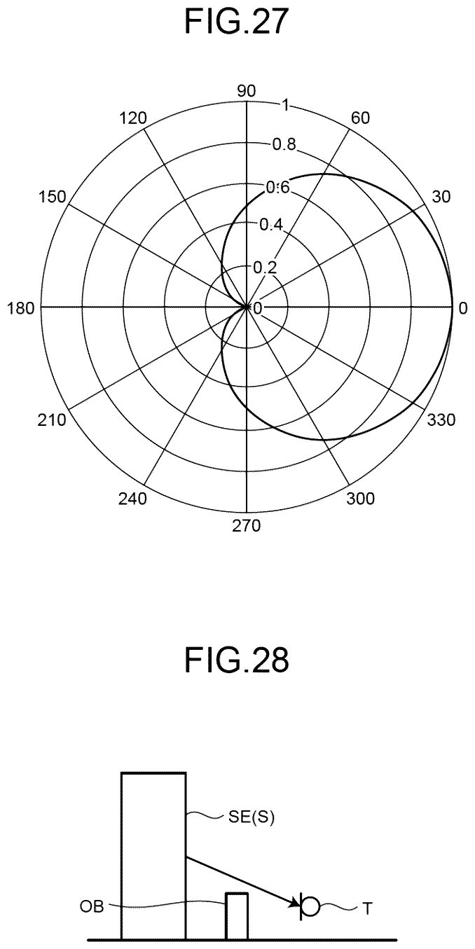

FIG. 27 is a diagram illustrating an example of the directivity of the sound source S. In the example of FIG. 27, a directional characteristic in which sound is strongly emitted in the direction of 0 degrees and no sound is emitted in the direction of 180 degrees is illustrated. As described above, since the sound is not emitted strongly in the direction of 180 degrees with respect to the sound source S, the diffracted sound generated in this direction is small. Therefore, it is possible to perform processing of ignoring propagation of sound in a direction of 180 degrees.

### 5. Modification 2: Constraint on Audio Signal Generation Processing Based on Size of Sound-Emitting Site

The necessity of the generation processing of the diffracted sound may be determined on the basis of the size of the sound-emitting site SE. The sound-emitting site SE means a site on the object that outputs the sound. FIG. 28 is a diagram for explaining the relationship between the size of the sound-emitting site SE and the diffracted sound.

In a case where the size of the sound-emitting site SE is larger than that of the object OB in which the diffraction phenomenon occurs, it is considered that the direct sound directly reaching the sound receiving point T is dominant over the diffracted sound. Therefore, in such a case, the processing of calculating the diffracted sound can be omitted. For example, the signal processing unit 139 calculates the ratio of direct sound reaching the sound receiving point T from the sound-emitting site SE via the diffraction site DF. The signal processing unit 139 can constrain the generation of the diffracted sound with respect to the sound-emitting site SE in which the ratio of the direct sound becomes larger than the allowable criteria. The allowable criteria can be arbitrarily set.

### 6. Modification 3: Mesh Size of Subspace

The IR generation unit 133 may change the mesh size of the subspace SB used in the wave acoustic simulation according to the size of the object OB in which the diffraction phenomenon occurs. In a case where the size of the object is large, only low-frequency sound is diffracted. Therefore, for example, in the case of an obstacle of 5 m, if an assumption is given that diffraction occurs only up to 340 Hz (a frequency of a wavelength of 1 m), which is a frequency up to ⅕ of the size, the mesh size can be set to 10 cm or the like. In general, in the FDTD, it is considered to be preferable to set the mesh size to a mesh size of a wavelength of 1/20 to 1/10 of an upper limit frequency of interest. When the size of the obstacle becomes smaller, diffraction occurs up to a higher frequency, so that it is preferable to set the mesh size more finely.

### 7. Modification 4: Setting Example of Subspace According to Size of Gap Between Objects

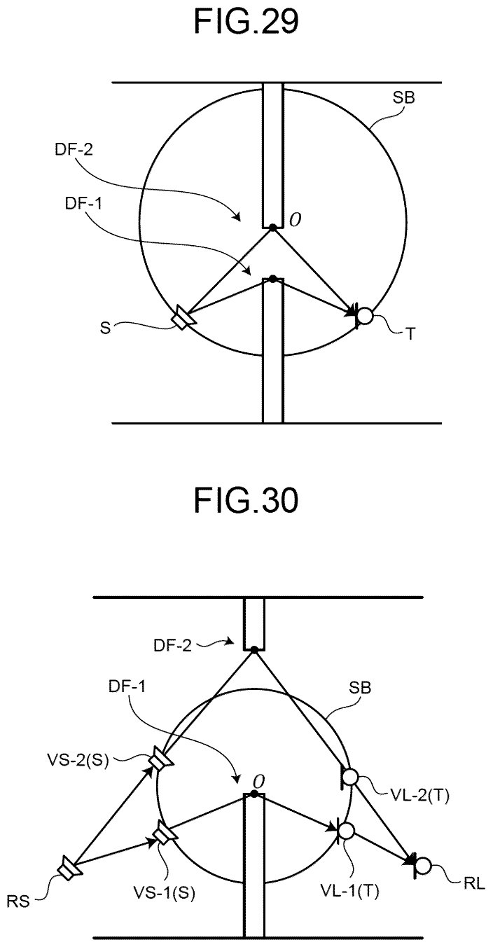

FIGS. 29 and 30 are diagrams for explaining a method of setting the subspace SB in a case where there is a gap between two objects OB.

When there is a gap between the two objects OB and it is desired to obtain IR of the diffracted sound generated in the gap, the identification unit 132 sets the subspace SB so as to include all the edges (diffraction sites DF-1 and DF-2) of each object OB. This makes it possible to accurately obtain IR of the diffracted sound due to the gap.

On the other hand, in a case where the distance between the edges is sufficiently long, as illustrated in FIG. 30, the identification unit 132 sets a subspace SB centered on the edge (diffraction site DF-1) that is the shortest path between the sound source S and the sound receiving point T. The identification unit 132 calculates IR between the virtual sound source VS-1 and the virtual sound receiving point VL-1, and performs delay/gain adjustment on the calculated IR to obtain IR from the real sound source RS to the real sound receiving point RL. Whether or not the edges are sufficiently separated can be determined on the basis of a threshold value. As the threshold value, for example, a value such as 3 m is used.

### 8. Modification 5: Two-Dimensional Subspace

The subspace SB in the three-dimensional virtual space V can be set as a three-dimensional space such as a sphere. However, in order to reduce the memory and the calculation amount of the subspace SB, it is also conceivable to convert the three-dimensional subspace SB into the two-dimensional subspace SB and perform the calculation of IR of the three-dimensional space in a pseudo manner in the two-dimensional space. Specific examples will be described below.

### 8-1. Case where Sound Source and Sound Receiving Point are on Same Coordinate Plane

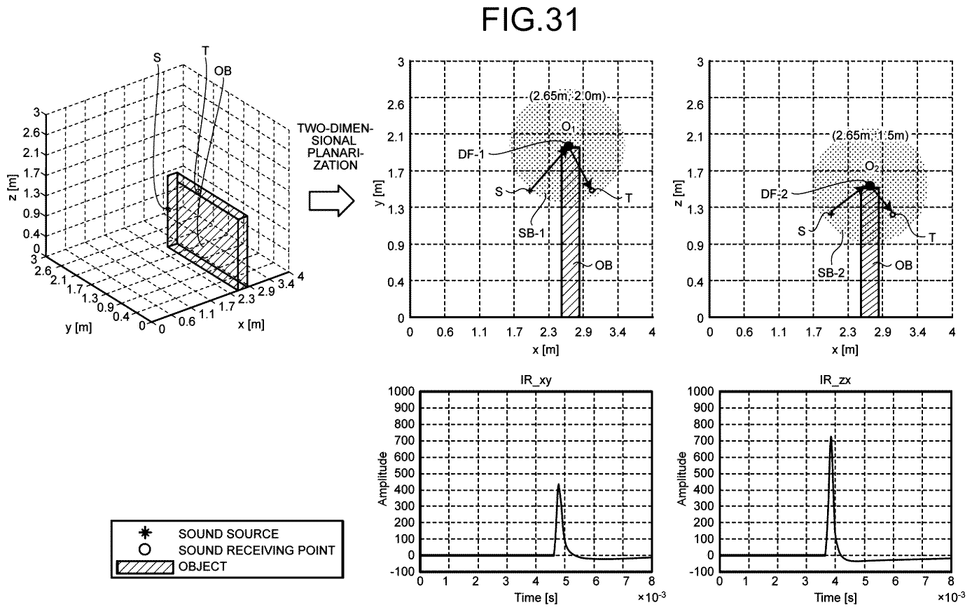

FIG. 31 is a diagram for explaining an operation example in a case where the sound source S and the sound receiving point T are on the same coordinate plane.

The three-dimensional coordinates of the sound source S and the sound receiving point T, and the configuration of the width, thickness, and the like of the object OB are as follows. For example, the object OB is a wall capable of diffracting the sound from the sound source S at the edges of the upper portion and the side portion.
Sound source: (2.0 m, 1.5 m, 1.2 m)
Sound receiving point: (3.0 m, 1.5 m, 1.2 m)
Width of object in x direction: 0.3 m
Width of object in y direction: 2.0 m
Width of object in z direction: 1.5 m

The sound source S and the sound receiving point T exist on the same xy plane (z=1.2 m). Therefore, the diffraction path DR of the diffracted sound that first arrives at the sound receiving point T through the edge of the side portion of the object OB also exists on the same xy plane as the sound source S and the sound receiving point T. In the example of FIG. 31, the coordinates of the diffraction site DF-1 (edge of the side portion of the object OB) are (2.65 m, 2.0 m). The identification unit 132 sets a circular subspace SB-1 having the diffraction site DF-1 as the center O₁ on the xy plane of z=1.2 m. The IR generation unit 133 performs wave acoustic simulation on the subspace SB-i and generates IR (IR_xy) in the xy two-dimensional space.

Similarly, the sound source S and the sound receiving point T exist on the same zx plane (y=1.5 m). Therefore, the diffraction path DR of the diffracted sound that first arrives at the sound receiving point T through the edge of the upper portion of the object OB also exists on the same zx plane as the sound source S and the sound receiving point T. In the example of FIG. 31, the coordinates of the diffraction site DF-2 (the edge of the upper portion of the object OB) are (2.65 m, 1.5 m). The identification unit 132 sets a circular subspace SB-2 having the diffraction site DF-2 as the center O₂ on the zx plane of y=1.5 m. The IR generation unit 133 performs wave acoustic simulation on the subspace SB-2 and generates IR (IR_zx) in the zx two-dimensional space.

The manner of sound attenuation differs between propagation in a three-dimensional space and propagation in a two-dimensional space. The IR generation unit 133 adjusts a gain of IR obtained in the two-dimensional space on the basis of a difference in distance attenuation between the two-dimensional space and the three-dimensional space. For example, the distance attenuation in the three-dimensional space is theoretically ½ times the amplitude when the distance is doubled. The distance attenuation in the two-dimensional space theoretically becomes 1/√2 times the amplitude when the distance is doubled. In the example of FIG. 31, since simulation is performed in a two-dimensional space, correction by distance attenuation is necessary.

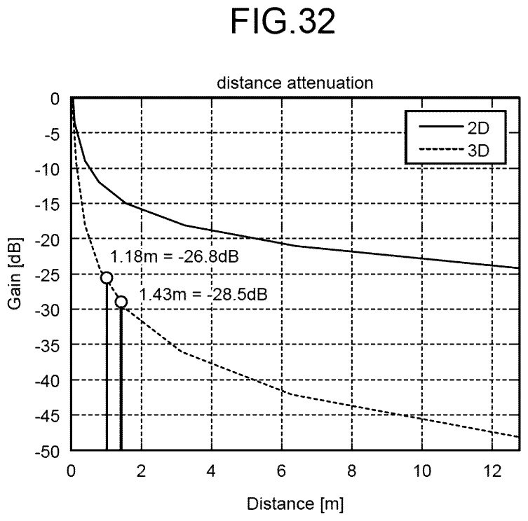

FIG. 32 is a diagram illustrating an example of distance attenuation in a two-dimensional space and a three-dimensional space.

The distance attenuation curve is theoretically a curve as illustrated in FIG. 32. Even in the case of propagating at the same distance, the attenuation is larger in the case of propagating with a three-dimensional spread than in the case of propagating with a two-dimensional spread. The magnitude of attenuation may be calculated on the basis of physical laws, but there may be a case where a sound designer wants to emphasize sound at a game production site. In this case, the distance attenuation curve may be separately set by the sound designer.

In the example of FIG. 31, the distance from the sound source S to the sound receiving point T via the edge (diffraction site DF-1) of the side portion of the object OB is 1.43 m. The distance is acquired on the basis of the path information output from the path search unit 131. Referring to FIG. 32, the distance attenuation in three-dimensional space in a case where the distance is 1.43 m is −28.5 dB (0.0376 in linear scale). The distance from the sound source S to the sound receiving point T via the edge of the upper portion (diffraction site DF-2) of the object OB is 1.18 m. Referring to FIG. 32, the distance attenuation in three-dimensional space in a case where the distance is 1.18 m is −26.8 dB (0.0457 in linear scale).

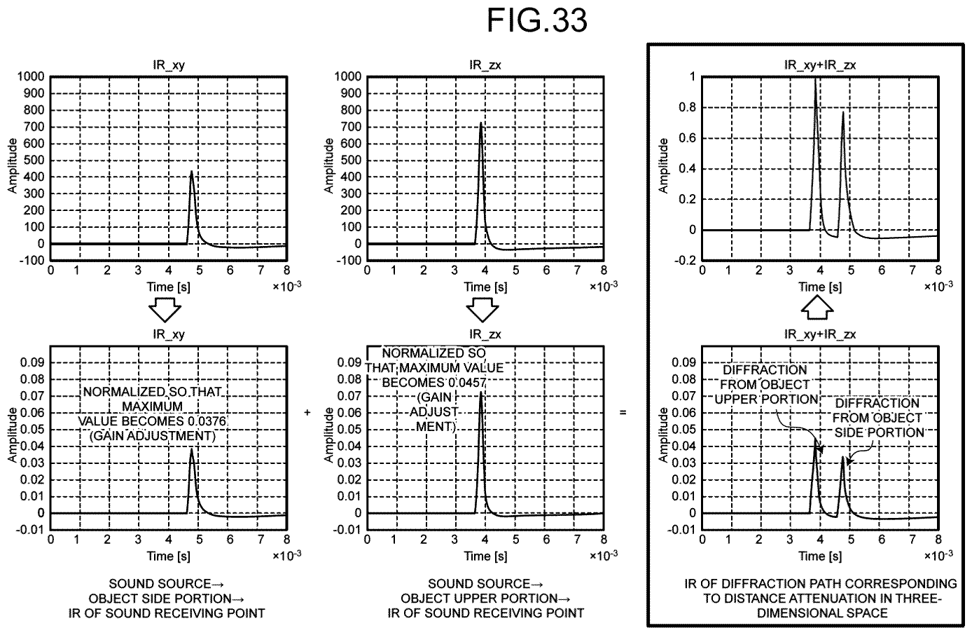

FIG. 33 is a diagram for explaining gain adjustment for each diffraction path DR.

The IR generation unit 133 performs gain adjustment based on the distance attenuation information in FIG. 31 on IR_xy obtained in the subspace SB-i on the xy plane and IR_zx obtained in the subspace SB-2 on the zx plane. The left side of FIG. 33 illustrates a state of gain adjustment of IR_xy. The central portion of FIG. 33 illustrates a state of gain adjustment of IR_zx. The right side of FIG. 33 illustrates a state of integration processing of IR_xy and IR_zx after gain adjustment.

The IR generation unit 133 can calculate IR in which the diffracted sound from the side and the diffracted sound from the top with respect to the object OB are observed by adding IR_xy and IR_zx after the gain adjustment on the time axis. The IR generation unit 133 may calculate IR in which the maximum value is normalized to 1 as necessary (see the upper right part of FIG. 33). In the example of FIG. 33, the maximum value becomes 1 by dividing the value of the data by 0.0457. This processing is equivalent to +26.8 dB. The sound designer can also perform final gain adjustment by considering sound balance. Since there is a possibility that the normalization parameter when the maximum value is set to 1 and the numerical value of +26.8 dB (0.0457 in linear scale) will be used as a reference when the sound designer adjusts the gain later, they may be separately held in the storage unit 120.

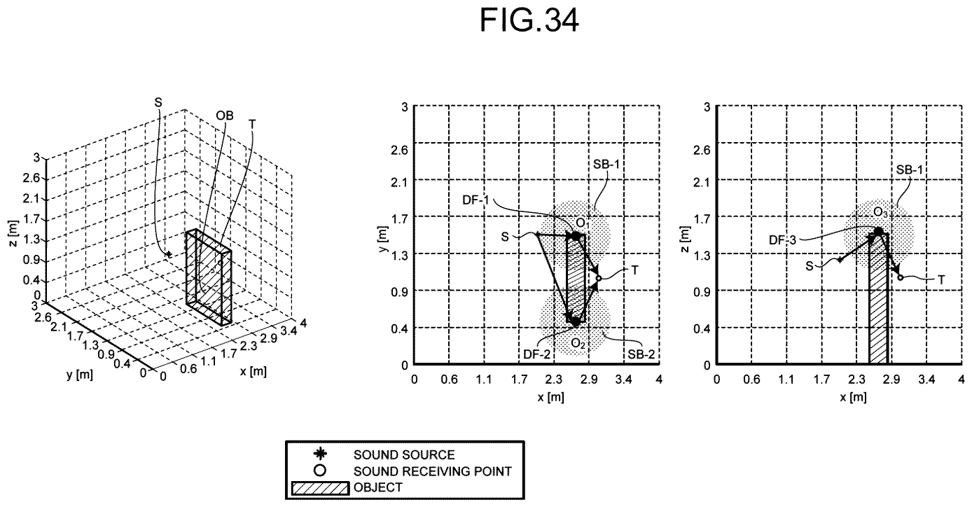

FIG. 34 is a diagram illustrating an example in which the diffraction path DR exists in three directions.

In the example of FIG. 34, there are a diffraction path DR passing through the left edge (diffraction site DF-1) of the object OB, a diffraction path DR passing through the right edge (diffraction site DF-2) of the object OB, and a diffraction path DR passing through the upper edge (diffraction site DF-3) of the object OB. The identification unit 132 sets a subspace SB-1, a subspace SB-2, and a subspace SB-3 corresponding to the diffraction site DF-1, the diffraction site DF-2, and the diffraction site DF-3. The IR generation unit 133 performs the wave acoustic simulation for each subspace SB. The IR generation unit 133 performs gain adjustment on the IR obtained for each subspace SB, and integrates the three IRs after the gain adjustment on the time axis.

In the examples illustrated in FIGS. 31 and 34, the diffracted sound generated in the three-dimensional space is handled in a two-dimensional plane. The identification unit 132 sets a two-dimensional space including the sound source S and the sound receiving point T on the same coordinate plane as the subspace SB. The IR generation unit 133 calculates IR in the subspace SB configured as a two-dimensional space. Therefore, it is possible to calculate the diffracted sound in the three-dimensional space in a pseudo manner while reducing the calculation amount.

### 8-2. Case where Sound Source and Sound Receiving Point are not on Same Coordinate Plane

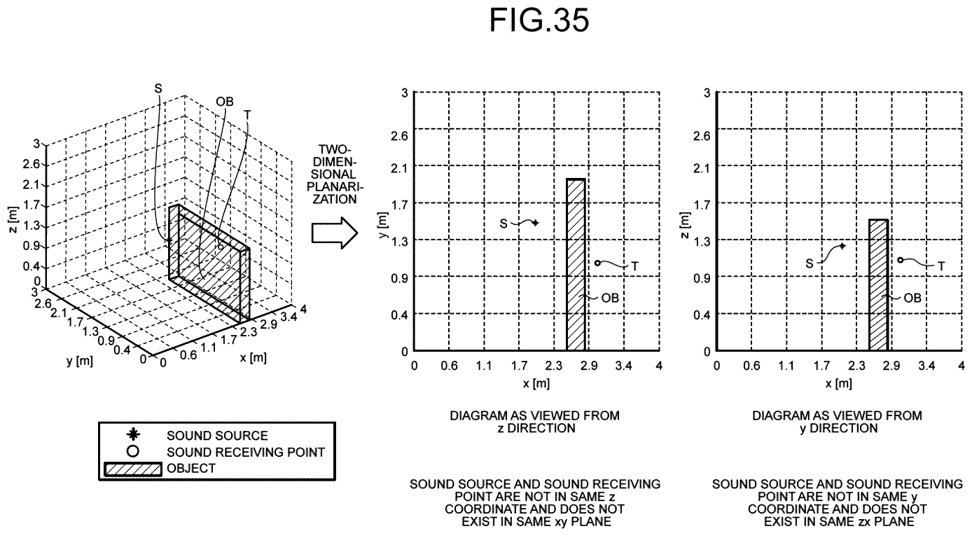

FIG. 35 is a diagram for explaining an operation example in a case where the sound source S and the sound receiving point T are not on the same coordinate plane.

The three-dimensional coordinates of the sound source S and the sound receiving point T, and the configuration of the width, thickness, and the like of the object OB are as follows. For example, the object OB is a wall capable of diffracting the sound from the sound source S at the edges of the upper portion and the side portion.
Sound source: (2.0 m, 1.5 m, 1.2 m)
Sound receiving point: (3.0 m, 1.0 m, 1.0 m)
Width of object in x direction: 0.3 m
Width of object in y direction: 2.0 m
Width of object in z direction: 1.5 m

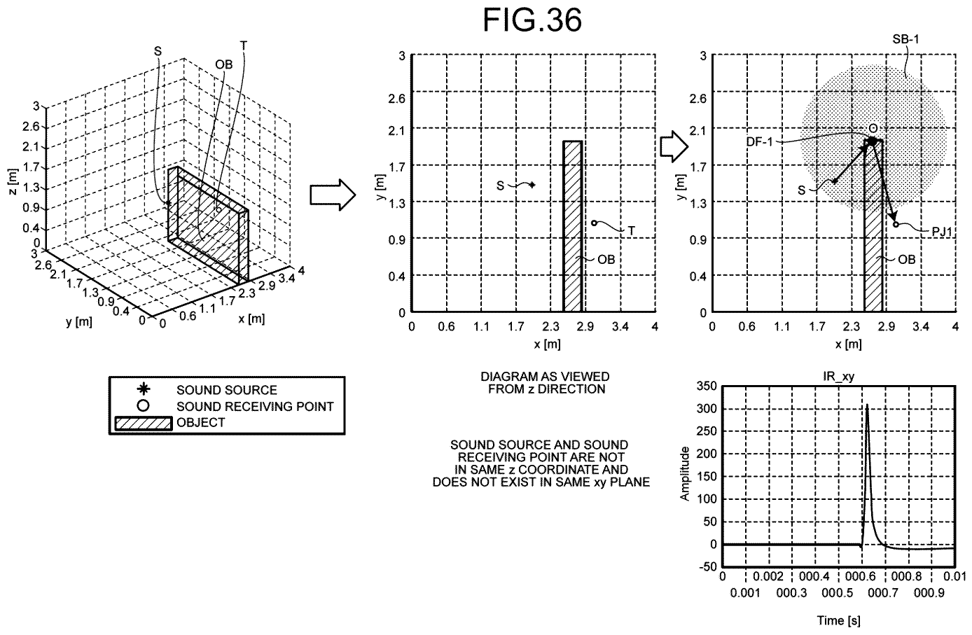

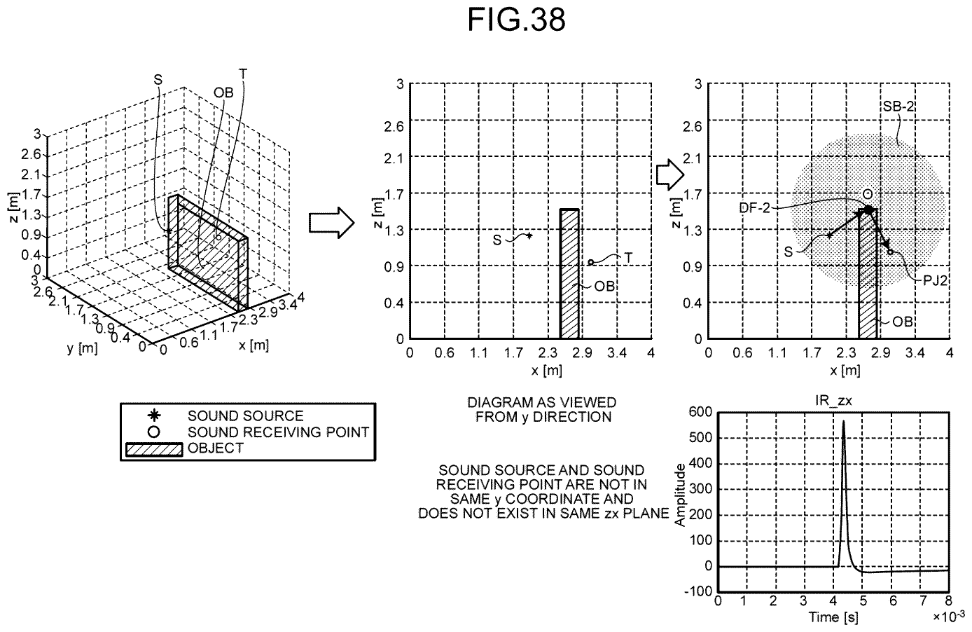

Since the sound source S and the sound receiving point T have different z coordinates, they do not exist on the same xy plane. Therefore, the IR generation unit 133 first generates IR by a method similar to that in FIG. 31 on the assumption that the sound source S and the sound receiving point T are on the same xy plane. Thereafter, the IR generation unit 133 corrects IR on the basis of the difference between the z coordinates of the sound source S and the sound receiving point T. As a result, IR of the diffracted sound passing through the edge (diffraction site DF-1) of the side portion of the object OB is generated. Similarly, the sound source S and the sound receiving point T do not exist on the same zx plane because the y coordinates are different. Therefore, the IR generation unit 133 generates the IR of the diffracted sound passing through the edge of the upper portion (diffraction site DF-2: see FIG. 38) of the object OB using a similar method. A specific description will be given below with reference to FIGS. 36 to 40.

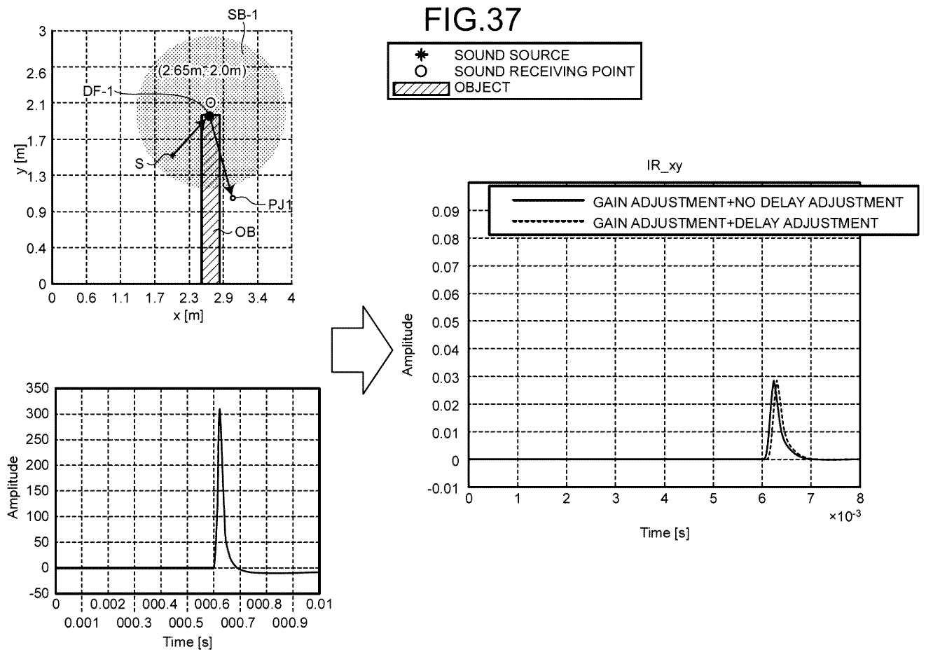

FIGS. 36 and 37 are diagrams for explaining generation processing of a diffracted sound passing through an edge (diffraction site DF-1) of a side portion of an object OB.

The identification unit 132 projects the sound receiving point T that is not on the same coordinate plane as the sound source S on the same coordinate plane as the sound source S. In the example of FIG. 36, the coordinate plane to be projected is an xy plane of z=1.2 m. In FIG. 36, a reference sign PJ1 indicates a projection point on the xy plane obtained by projecting the sound receiving point T on the xy plane same as the sound source S. The identification unit 132 sets a two-dimensional space on the xy plane including the sound source S and the projection point PJ1 as a subspace SB-1.

The IR generation unit 133 performs wave acoustic simulation on the set two-dimensional subspace SB-1 and calculates IR_xy in the subspace SB-1 (see the lower right of FIG. 36). The identification unit 132 calculates a difference between the distance on the diffraction path DR between the sound source S and the sound receiving point T and the distance on the diffraction path between the sound source S and the projection point PJ1. The identification unit 132 calculates the delay time Ti by dividing the difference by the sound speed. The identification unit 132 obtains the amplitude attenuation rate according to the difference using the distance attenuation curve or the like in FIG. 32. The IR generation unit 133 adds the amplitude attenuation rate and the delay time τ₁ according to the difference to IR_xy. As a result, IR_xy1 in which the delay time τ₁ and the gain are adjusted is acquired (see the right side of FIG. 37). In this example, since the value of the amplitude attenuation rate in the three-dimensional space according to the distance is 0.0279 from FIG. 32, the maximum amplitude is adjusted to be 0.0279.

For example, in the example of FIG. 36, the coordinates of the projection point PJ1 are (3.0 m, 1.0 m, 1.2 m). The coordinates of the sound receiving point T are (3.0 m, 1.0 m, 1.0 m). The coordinates of the diffraction site DF-1 on the xy plane (z=1.2 m) are (2.65 m, 2.0 m, 1.2 m). The distance on the diffraction path between the sound source S and the projection point PJ1 is 1.8795 m. The distance on the diffraction path DR between the sound source S and the sound receiving point T is 1.8983 m. Therefore, the difference is 0.0187 m. Assuming that the sound speed is 340 m/s, the delay time τ₁ is 0.055 milliseconds. A time waveform to which the delay time τ₁ is given is a time waveform displayed by a dotted line on the right side of FIG. 37.

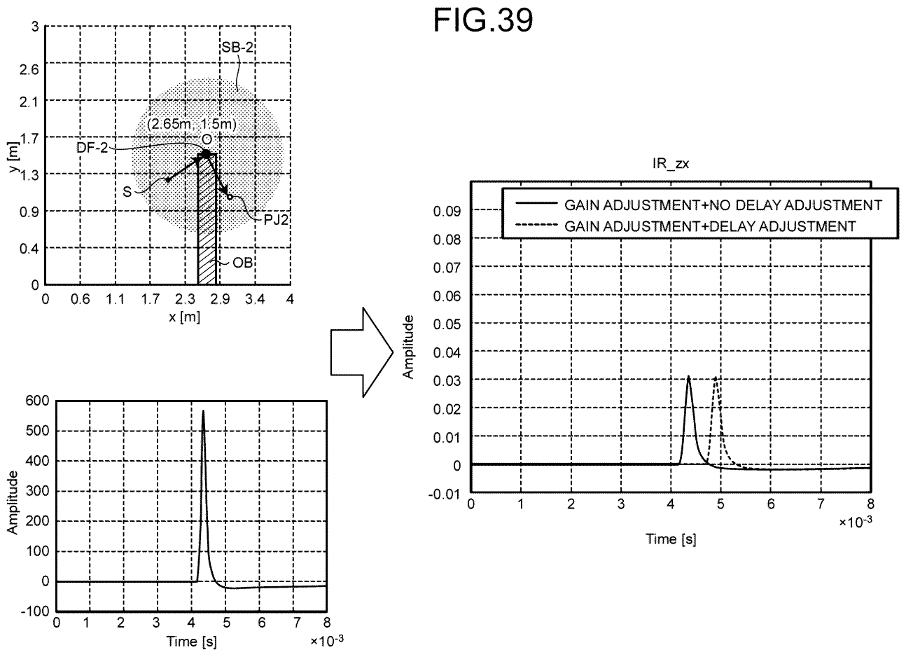

FIGS. 38 and 39 are diagrams for explaining generation processing of a diffracted sound passing through an edge of an upper portion (diffraction site DF-2) of an object OB.

The identification unit 132 projects the sound receiving point T that is not on the same coordinate plane as the sound source S on the same coordinate plane as the sound source S. In the example of FIG. 38, the coordinate plane to be projected is a zx plane of y=1.5 m. In FIG. 38, a reference sign PJ2 indicates a projection point on the zx plane obtained by projecting the sound receiving point T on the zx plane same as the sound source S. The identification unit 132 sets a two-dimensional space on the zx plane including the sound source S and the projection point PJ2 as a subspace SB-2.

The IR generation unit 133 performs wave acoustic simulation on the set two-dimensional subspace SB-2 and calculates IR_zx in the subspace SB-2 (see the lower right of FIG. 38). The identification unit 132 calculates a difference between the distance on the diffraction path DR between the sound source S and the sound receiving point T and the distance on the diffraction path between the sound source S and the projection point PJ2. The identification unit 132 calculates the delay time τ₂ by dividing the difference by the sound speed. The identification unit 132 obtains the amplitude attenuation rate according to the difference using the distance attenuation curve or the like in FIG. 32. The IR generation unit 133 adds the amplitude attenuation rate and the delay time τ₂ according to the difference to IR_zx. As a result, IR_zx1 with the delay time τ₂ and the gain adjusted is acquired (see the right side of FIG. 39). In this example, since the value of the amplitude attenuation rate in the three-dimensional space according to the distance is 0.0316 from FIG. 32, the maximum amplitude is adjusted to be 0.0316.

For example, in the example of FIG. 38, the coordinates of the projection point PJ2 are (3.0 m, 1.5 m, 1.0 m). The coordinates of the sound receiving point T are (3.0 m, 1.0 m, 1.0 m). The coordinates of the diffraction site DF-2 on the zx plane (y=1.5 m) are (2.65 m, 1.5 m, 1.5 m). The distance on the diffraction path between the sound source S and the projection point PJ2 is 1.4304 m. The distance on the diffraction path DR between the sound source S and the sound receiving point T is 1.6090 m. Therefore, the difference is 0.1787 m. Assuming that the sound speed is 340 m/s, the delay time τ₂ is 0.525 milliseconds. A time waveform to which the delay time τ₂ is given is a time waveform displayed by a dotted line on the right side of FIG. 39.

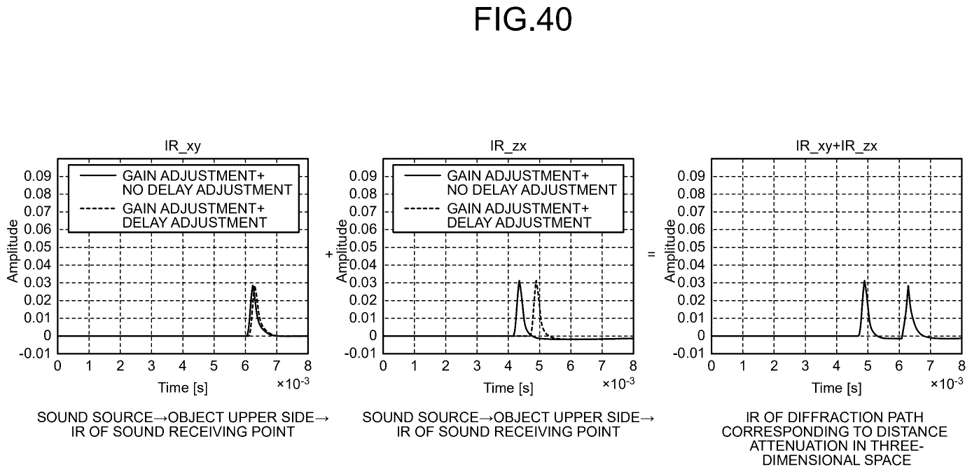

FIG. 40 is a diagram for explaining integration processing of a plurality of IRs having different diffraction paths DR.

The IR generation unit 133 adds IR_xy and IR_zx whose delay and gain have been adjusted on the time axis. As a result, it is possible to calculate IR of a complex diffracted sound obtained by combining a diffracted sound from a side portion of the object OB and a diffracted sound from an upper portion of the object OB.

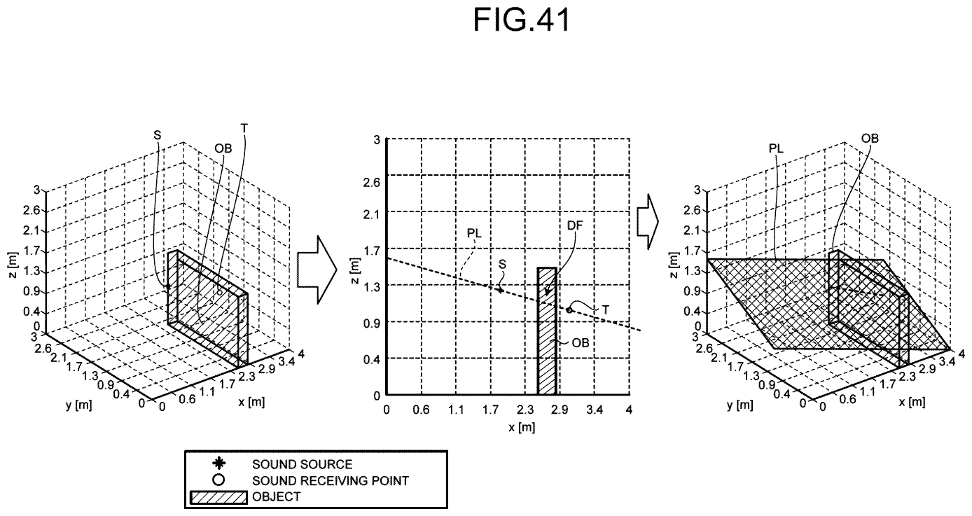

FIG. 41 is a diagram for explaining another calculation example in a case where the sound source S and the sound receiving point T are not on the same coordinate plane.

The three-dimensional coordinates of the sound source S and the sound receiving point T are as follows. The configuration such as the width and thickness of the object OB is similar to that in FIG. 31.
Sound source: (2.0 m, 1.5 m, 1.2 m)
Sound receiving point: (3.0 m, 1.0 m, 1.0 m)

In the present method, the two-dimensional subspace SB is set in the plane PL including the diffraction path DR connecting the sound source S and the sound receiving point T at the shortest distance. In the example of FIG. 41, a plane obtained by connecting the sound source S and the sound receiving point T with a straight line, observing the straight line on the zx plane, and translating the straight line in the y direction is the plane PL in which the subspace SB is set. For example, the identification unit 132 sets a two-dimensional space including the sound source S and the sound receiving point T on the same plane PL as the subspace SB. The IR generation unit 133 calculates IR in the subspace SB configured as a two-dimensional space. As a result, IR of the diffracted sound passing through the edge (diffraction site DF) of the side portion of the object OB is generated.

A similar method is used in the case of generating IR of the diffracted sound passing through the edge of the upper portion of the object OB. In this case, the plane PL in which the subspace SB is set is a plane obtained by connecting the sound source S and the sound receiving point T by a straight line, observing the straight line in the xy plane, and translating the straight line in the z direction.

### 9. Modification 6: Generation of IR Based on Encoded Object Information

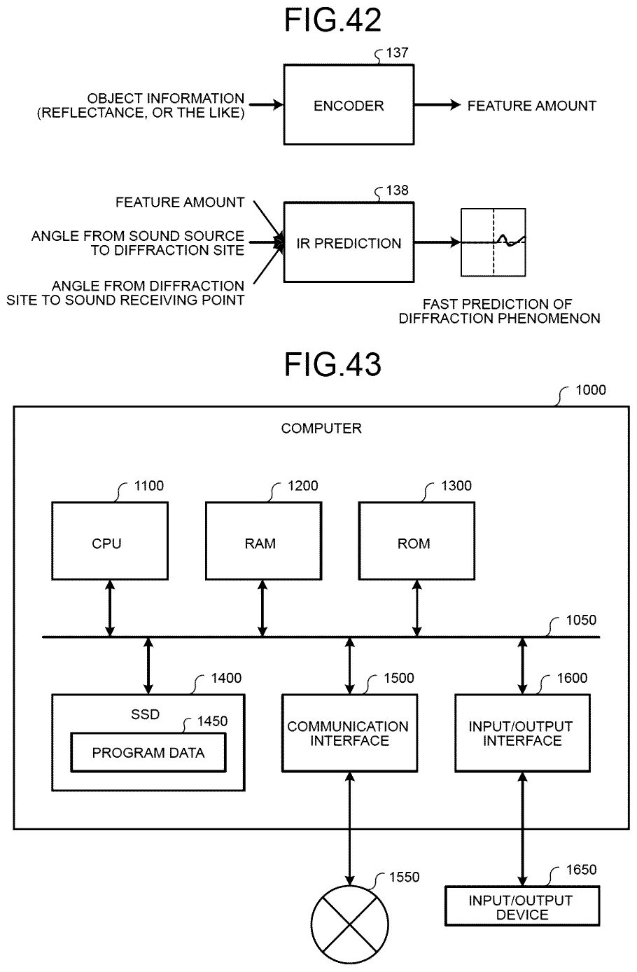

FIG. 42 is a diagram for explaining an example of IR generation based on encoded object information.

The signal processing unit 139 generates IR using an AI model including an encoder unit 137 and an IR prediction unit 138. The encoder unit 137 compresses data of various object shapes and converts the data into a certain feature amount. The IR prediction unit 138 outputs IR on the basis of the feature amount acquired from the encoder unit 137.

The encoder unit 137 encodes object information (diffraction site information) related to the diffraction site DF and outputs a feature amount. The input is the diffraction site information, and the output is the dimensionally compressed feature amount. The diffraction site information includes information regarding texture, material, size, density, internal sound speed, sound absorption coefficient (reflectance), acoustic impedance, and the like of the diffraction site DF. The IR prediction unit 138 uses the feature amount output from the encoder, the angle from the sound source S to the diffraction site DF, and the angle from the diffraction site DF to the sound receiving point T as inputs, and outputs IR expressing only the diffracted sound corresponding to the inputs.

### 10. Hardware Configuration Example

The information equipment such as the acoustic processing apparatus 100 according to the above-described embodiments is implemented by, for example, a computer 1000 having a configuration as illustrated in FIG. 43. FIG. 43 is a hardware configuration diagram illustrating an example of the computer 1000 that implements the functions of the acoustic processing apparatus 100. The computer 1000 includes a CPU 1100, a RAM 1200, a read only memory (ROM) 1300, a solid state drive (SSD) 1400, a communication interface 1500, and an input/output interface 1600. Each unit of the computer 1000 is connected by a bus 1050.

The CPU 1100 operates on the basis of a program stored in the ROM 1300 or the SSD 1400, and controls each unit. For example, the CPU 1100 develops a program stored in the ROM 1300 or the SSD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The SSD 1400 is a computer-readable recording medium that non-transiently records a program executed by the CPU 1100, data used by the program, and the like. Specifically, the SSD 1400 is a recording medium that records an information processing program according to the present disclosure, which is an example of program data 1450. The SSD 1400 may be another non-transitory recording medium such as a hard disk drive (HDD).

The communication interface 1500 is an interface for the computer 1000 to connect to an external network 1550 (for example, the Internet). For example, the CPU 1100 receives data from other equipment or transmits data generated by the CPU 1100 to other equipment via the communication interface 1500.

The input/output interface 1600 is an interface for connecting an input/output device 1650 and the computer 1000. For example, the CPU 1100 receives data from an input device such as a touch panel, a keyboard, a mouse, a microphone, or a camera via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the acoustic processing apparatus 100 according to the present embodiments, the CPU 1100 of the computer 1000 implements the functions of the control unit 130 and the like by executing the information processing program loaded on the RAM 1200. In addition, the SSD 1400 stores an information processing program according to the present disclosure and data in the storage unit 120. Note that the CPU 1100 reads the program data 1450 from the SSD 1400 and executes the program data, but as another example, these programs may be acquired from another apparatus via the external network 1550.

### 11. Effects

The acoustic processing method of the present disclosure includes diffraction path search processing and diffracted sound generation processing. In the diffraction path search processing, the diffraction path DR from the sound source S to the sound receiving point T is searched for. In the diffracted sound generation processing, the diffracted sound acquired at the sound receiving point T is generated on the basis of the wave acoustic simulation in which the simulation time is constrained according to the distance of the diffraction path DR. The acoustic processing apparatus of the present disclosure performs information processing defined in the acoustic processing method. The acoustic processing program of the present disclosure implements information processing defined in the acoustic processing method.

According to this configuration, an appropriate temporal constraint according to the distance of the diffraction path DR is applied to the wave acoustic simulation. Therefore, a realistic sound experience is provided with a small calculation amount.

In the generation processing of the diffracted sound, the time until the diffracted sound first reaches the sound receiving point T is calculated as the arrival time t₀ on the basis of the distance of the diffraction path DR. In the generation processing of the diffracted sound, a time equal to or more than 1 time and equal to or less than 5 times the arrival time t₀ is set as the simulation time.

According to this configuration, simulation can be performed up to a time at which diffracted sound can be sufficiently observed while minimizing the calculation amount.

The diffracted sound generation processing includes IR generation processing. In the IR generation processing, the diffraction site DF on the object OB where the diffraction phenomenon occurs is acquired. In the generation processing of IR, the wave acoustic simulation is selectively performed on the subspace SB including the diffraction site DF, thereby generating IR in the subspace SB.

According to this configuration, an appropriate spatial constraint specialized for the vicinity of the diffraction site DF is applied to the simulation. Therefore, a realistic sound experience is provided with a small calculation amount.

In the IR generation processing, the IR is generated using the AI model. The AI model is a learned neural network in which a relationship between a simulation condition of the wave acoustic simulation and a simulation result obtained in the simulation condition is learned as a relationship between input data and correct answer data.

According to this configuration, it is not necessary to hold enormous data prepared in advance. Therefore, the processing can be performed lightly without putting pressure on the memory or the like.

The AI model encodes object information regarding the diffraction site DF and outputs a feature amount. The AI model outputs IR on the basis of the output feature amount.

According to this configuration, an appropriate IR that captures the features of the diffraction site DF is generated.

The subspace SB is a space including at least one of the sound source S or the sound receiving point T.

According to this configuration, the subspace SB to be simulated can be made as small as possible.

The sound source S is a virtual sound source VS set on the diffraction path DR between the real sound source RS and the diffraction site DF. In the IR generation processing, an amplitude attenuation rate and a delay time according to an attenuation distance between the real sound source RS and the virtual sound source VS are added to IR.

According to this configuration, the subspace SB to be simulated can be further limited to the vicinity of the diffraction site DF.

The sound receiving point T is a virtual sound receiving point set on the diffraction path DR between the real sound receiving point RL and the diffraction site DF. In the IR generation processing, an amplitude attenuation rate and a delay time according to an attenuation distance between the real sound receiving point RL and the virtual sound receiving point are added to IR.

According to this configuration, the subspace SB to be simulated can be further limited to the vicinity of the diffraction site DF.

The acoustic processing method of the present disclosure includes setting processing of the subspace SB. In the setting processing of the subspace SB, a size that can be simulated in one frame period is acquired as a maximum size. In the setting processing of the subspace SB, the subspace SB is set as a space having a size equal to or smaller than the maximum size.

According to this configuration, an appropriate simulation is performed within a range in which real-time processing is possible. Therefore, the natural diffracted sound can be presented in real time.

In the setting processing of the subspace SB, the subspace SB is set as a space including the surface area or the volume of the object OB by a preset ratio.

According to this configuration, since the surface area or the volume of the object OB is covered to some extent, the outline of the object OB is well understood. Therefore, an appropriate diffracted sound is generated.

In the setting processing of the subspace SB, one or more diffraction sites DF that can be included in the subspace SB are extracted from a plurality of diffraction sites DF included in the same object OB. In the IR generation processing, the wave acoustic simulation is selectively performed on the extracted one or more diffraction sites DF.

According to this configuration, sound quality and a processing speed can be balanced.

The subspace SB is a spherical or circular space centered on the diffraction site DF.

According to this configuration, calculation is facilitated.

The setting processing of the subspace SB detects a plurality of diffraction sites DF that diffracts the sound output from the sound source S toward the sound receiving point T. In the setting processing of the subspace SB, the plurality of detected diffraction sites DF is classified into a plurality of groups on the basis of the maximum size. In the setting processing of the subspace SB, the subspace SB is set for each of the classified groups. In the IR generation processing, an amplitude attenuation rate and a delay time according to the distance between the subspaces SB along the diffraction path DR are added to IR.

According to this configuration, a real high-order diffracted sound is generated with a small calculation amount.

The generation processing of the diffracted sound makes it possible to constrain the generation of the diffracted sound passing through the number of subspaces SB exceeding a preset allowable number.

According to this configuration, the generation of the diffracted sound in which the number of times of diffraction is large and the amplitude is extremely decreased is constrained. As a result, the calculation amount can be suppressed without impairing the sound quality.

The generation processing of the diffracted sound makes it possible to constrain the generation of the diffracted sound passing through the diffraction path DR having a length exceeding a preset allowable length.

According to this configuration, the generation of the diffracted sound in which the propagation distance is long and the amplitude is extremely decreased is constrained. As a result, the calculation amount can be suppressed without impairing the sound quality.

In the IR generation processing, the mesh size of the subspace SB used in the wave acoustic simulation is changed according to the size of the object OB.

According to this configuration, the simulation can be appropriately performed while suppressing the calculation amount.

In the setting processing of the subspace SB, the sound receiving point T that is not on the same coordinate plane as the sound source S is projected on the coordinate plane. In the setting processing of the subspace SB, the two-dimensional space on the coordinate plane including the sound source S and the projection point on the coordinate plane is set as the subspace SB. The IR generation processing calculates IR in the subspace SB. In the IR generation processing, an amplitude attenuation rate and a delay time according to a difference between a distance on the diffraction path DR between the sound source S and the sound receiving point T and a distance on the diffraction path DR between the sound source S and the projection point are added to IR.

According to this configuration, IR calculation in a three-dimensional space can be performed in a pseudo two-dimensional space. Therefore, the calculation amount can be reduced.

In the setting processing of the subspace SB, a two-dimensional space including the sound source S and the sound receiving point T on the same plane PL is set as the subspace SB. The IR generation processing calculates IR in the subspace SB.

According to this configuration, IR calculation in a three-dimensional space can be performed in a pseudo two-dimensional space. Therefore, the calculation amount can be reduced.

In the diffracted sound generation processing, an allowable propagation direction in which sound propagation is allowed is acquired on the basis of the directivity of the sound source S. The generation processing of the diffracted sound makes it possible to constrain the generation of the diffracted sound propagating in a direction other than the allowable propagation direction.

According to this configuration, the generation of the diffracted sound in the direction in which the emission of the sound is extremely reduced according to the directivity is constrained. As a result, the calculation amount can be suppressed without impairing the sound quality.

In the generation processing of the diffracted sound, the ratio of direct sound reaching the sound receiving point T from the sound-emitting site SE via the diffraction site DF is calculated. The generation processing of the diffracted sound makes it possible to constrain the generation of the diffracted sound for the sound-emitting site SE in which the ratio of the direct sound becomes larger than the allowable criteria.

According to this configuration, the generation of the diffracted sound is constrained for the sound-emitting site where the direct sound is dominant over the diffracted sound. As a result, the calculation amount can be suppressed without impairing the sound quality.

Note that the effects described in the present specification are merely examples and are not limited, and other effects may be provided.

### Supplementary Note

Note that the present technology can also adopt the following configurations.

(1)

An acoustic processing method executed by a computer, the acoustic processing method comprising:
searching a diffraction path from a sound source to a sound receiving point; and
generating a diffracted sound acquired at the sound receiving point on a basis of a wave acoustic simulation with a simulation time constrained according to a distance of the diffraction path.
(2)

The acoustic processing method according to (1), wherein
in the generation processing of the diffracted sound, time until the diffracted sound first reaches the sound receiving point is calculated as arrival time on a basis of the distance of the diffraction path, and time equal to or more than 1 time and equal to or less than 5 times the arrival time is set as the simulation time.
   (3)

The acoustic processing method according to (1) or (2), wherein
the generation processing of the diffracted sound includes acquiring a diffraction site on an object in which a diffraction phenomenon occurs and selectively performing the wave acoustic simulation on a subspace including the diffraction site to generate an impulse response in the subspace.
   (4)

The acoustic processing method according to (3), wherein
in the generation processing of the impulse response, the impulse response is generated using a learned AI model in which a relationship between a simulation condition of the wave acoustic simulation and a simulation result obtained in the simulation condition is learned as a relationship between input data and correct answer data.
   (5)

The acoustic processing method according to (4), wherein
the AI model encodes object information regarding the diffraction site to output a feature amount, and outputs the impulse response on a basis of the feature amount.
   (6)

The acoustic processing method according to any one of (3) to (5), wherein
the subspace is a space including at least one of the sound source or the sound receiving point.
(7)

The acoustic processing method according to (6), wherein
the sound source is a virtual sound source set on the diffraction path between a real sound source and the diffraction site, and
the generation processing of the impulse response adds an amplitude attenuation rate and a delay time according to an attenuation distance between the real sound source and the virtual sound source to the impulse response.
   (8)

The acoustic processing method according to (6) or (7), wherein
the sound receiving point is a virtual sound receiving point set on the diffraction path between a real sound receiving point and the diffraction site, and
the generation processing of the impulse response adds an amplitude attenuation rate and a delay time according to an attenuation distance between the real sound receiving point and the virtual sound receiving point to the impulse response.
(9)

The acoustic processing method according to any one of (3) to (8), further comprising
acquiring a size that can be simulated in one frame period as a maximum size, and setting the subspace as a space having a size equal to or smaller than the maximum size.
   (10)

The acoustic processing method according to (9), wherein
in the setting processing of the subspace, the subspace is set as a space including a surface area or a volume of the object by a preset ratio.
   (11)

The acoustic processing method according to (9), wherein
in the setting processing of the subspace, one or more diffraction sites that can be included in the subspace are extracted from a plurality of diffraction sites included in a same object, and
in the generation processing of the impulse response, the wave acoustic simulation is selectively performed on the one or more diffraction sites extracted.
   (12)

The acoustic processing method according to any one of (9) to (11), wherein
the subspace is a spherical or circular space centered on the diffraction site.
   (13)

The acoustic processing method according to any one of (9) to (12), wherein
the setting processing of the subspace includes:
   detecting a plurality of diffraction sites that diffracts sound output from the sound source toward the sound receiving point;
   classifying the plurality of diffraction sites detected into a plurality of groups on a basis of the maximum size; and
   setting the subspace for each of the groups classified, and
the generation processing of the impulse response adds an amplitude attenuation rate and a delay time according to a distance between subspaces along the diffraction path to the impulse response.
   (14)

The acoustic processing method according to (13), wherein
the generation processing of the diffracted sound enables constraining generation of the diffracted sound passing through the number of subspaces exceeding a preset allowable number.
   (15)

The acoustic processing method according to any one of (3) to (14), wherein
the generation processing of the diffracted sound enables constraining generation of the diffracted sound passing through the diffraction path having a length exceeding a preset allowable length.
   (16)

The acoustic processing method according to any one of (3) to (15), wherein
in the generation processing of the impulse response, a mesh size of the subspace used in the wave acoustic simulation is changed according to a size of the object.
   (17)

The acoustic processing method according to any one of (3) to (16), wherein
the setting processing of the subspace includes:
   projecting the sound receiving point that is not on a same coordinate plane as the sound source on the coordinate plane; and
   setting a two-dimensional space on the coordinate plane including the sound source and a projection point on the coordinate plane as the subspace, and
the generation processing of the impulse response includes:
   calculating the impulse response in the subspace; and
   adding, to the impulse response, an amplitude attenuation rate and a delay time according to a difference between a distance on a diffraction path between the sound source and the sound receiving point and a distance on a diffraction path between the sound source and the projection point.
      (18)

The acoustic processing method according to any one of (3) to (16), wherein
in the setting processing of the subspace, a two-dimensional space including the sound source and the sound receiving point on a same plane is set as the subspace, and
the generation processing of the impulse response calculates the impulse response in the subspace.
   (19)

The acoustic processing method according to any one of (1) to (18), wherein
the generation processing of the diffracted sound enables acquiring an allowable propagation direction in which sound propagation is allowed on a basis of directivity of the sound source and constraining generation of the diffracted sound propagating in a direction other than the allowable propagation direction.
   (20)

The acoustic processing method according to any one of (1) to (19), wherein
the generation processing of the diffracted sound enables calculating a ratio of a direct sound reaching the sound receiving point from a sound-emitting site through a diffraction site and constraining generation of the diffracted sound for the sound-emitting site in which the ratio of the direct sound becomes larger than allowable criteria.
   (21)

An acoustic processing apparatus comprising:
a path search unit that searches a diffraction path from a sound source to a sound receiving point; and
a signal processing unit that generates a diffracted sound acquired at the sound receiving point on a basis of a wave acoustic simulation with a simulation time constrained according to a distance of the diffraction path.
   (22)

A computer-readable recording medium storing an acoustic processing program implemented by a computer, the acoustic processing program comprising:
searching a diffraction path from a sound source to a sound receiving point; and
generating a diffracted sound acquired at the sound receiving point on a basis of a wave acoustic simulation with a simulation time constrained according to a distance of the diffraction path.

### REFERENCE SIGNS LIST

100 ACOUSTIC PROCESSING APPARATUS
131 PATH SEARCH UNIT
139 SIGNAL PROCESSING UNIT
DF DIFFRACTION SITE
DR DIFFRACTION PATH
OB OBJECT
PJ1, PJ2 PROJECTION POINT
PL PLANE
RL REAL SOUND RECEIVING POINT
RS REAL SOUND SOURCE
S SOUND SOURCE
SB SUBSPACE
SE SOUND-EMITTING SITE
T SOUND RECEIVING POINT
t₀ ARRIVAL TIME
VL VIRTUAL SOUND RECEIVING POINT
VS VIRTUAL SOUND SOURCE

1. An acoustic processing method executed by a computer, the acoustic processing method comprising:
searching a diffraction path from a sound source to a sound receiving point; and
generating a diffracted sound acquired at the sound receiving point on a basis of a wave acoustic simulation with a simulation time constrained according to a distance of the diffraction path.

2. The acoustic processing method according to claim 1, wherein
in the generation processing of the diffracted sound, time until the diffracted sound first reaches the sound receiving point is calculated as arrival time on a basis of the distance of the diffraction path, and time equal to or more than 1 time and equal to or less than 5 times the arrival time is set as the simulation time.

3. The acoustic processing method according to claim 1, wherein
the generation processing of the diffracted sound includes acquiring a diffraction site on an object in which a diffraction phenomenon occurs and selectively performing the wave acoustic simulation on a subspace including the diffraction site to generate an impulse response in the subspace.

4. The acoustic processing method according to claim 3, wherein
in the generation processing of the impulse response, the impulse response is generated using a learned AI model in which a relationship between a simulation condition of the wave acoustic simulation and a simulation result obtained in the simulation condition is learned as a relationship between input data and correct answer data.

5. The acoustic processing method according to claim 4, wherein
the AI model encodes object information regarding the diffraction site to output a feature amount, and outputs the impulse response on a basis of the feature amount.

6. The acoustic processing method according to claim 3, wherein
the subspace is a space including at least one of the sound source or the sound receiving point.

7. The acoustic processing method according to claim 6, wherein
the sound source is a virtual sound source set on the diffraction path between a real sound source and the diffraction site, and
the generation processing of the impulse response adds an amplitude attenuation rate and a delay time according to an attenuation distance between the real sound source and the virtual sound source to the impulse response.

8. The acoustic processing method according to claim 6, wherein
the sound receiving point is a virtual sound receiving point set on the diffraction path between a real sound receiving point and the diffraction site, and
the generation processing of the impulse response adds an amplitude attenuation rate and a delay time according to an attenuation distance between the real sound receiving point and the virtual sound receiving point to the impulse response.

9. The acoustic processing method according to claim 3, further comprising
acquiring a size that can be simulated in one frame period as a maximum size, and setting the subspace as a space having a size equal to or smaller than the maximum size.

10. The acoustic processing method according to claim 9, wherein
in the setting processing of the subspace, the subspace is set as a space including a surface area or a volume of the object by a preset ratio.

11. The acoustic processing method according to claim 9, wherein
in the setting processing of the subspace, one or more diffraction sites that can be included in the subspace are extracted from a plurality of diffraction sites included in a same object, and
in the generation processing of the impulse response, the wave acoustic simulation is selectively performed on the one or more diffraction sites extracted.

12. The acoustic processing method according to claim 9, wherein
the subspace is a spherical or circular space centered on the diffraction site.

13. The acoustic processing method according to claim 9, wherein
the setting processing of the subspace includes:
detecting a plurality of diffraction sites that diffracts sound output from the sound source toward the sound receiving point;
classifying the plurality of diffraction sites detected into a plurality of groups on a basis of the maximum size; and
setting the subspace for each of the groups classified, and
the generation processing of the impulse response adds an amplitude attenuation rate and a delay time according to a distance between subspaces along the diffraction path to the impulse response.

14. The acoustic processing method according to claim 13, wherein
the generation processing of the diffracted sound enables constraining generation of the diffracted sound passing through the number of subspaces exceeding a preset allowable number.

15. The acoustic processing method according to claim 3, wherein
the generation processing of the diffracted sound enables constraining generation of the diffracted sound passing through the diffraction path having a length exceeding a preset allowable length.

16. The acoustic processing method according to claim 3, wherein
in the generation processing of the impulse response, a mesh size of the subspace used in the wave acoustic simulation is changed according to a size of the object.

17. The acoustic processing method according to claim 3, wherein
the setting processing of the subspace includes:
projecting the sound receiving point that is not on a same coordinate plane as the sound source on the coordinate plane; and
setting a two-dimensional space on the coordinate plane including the sound source and a projection point on the coordinate plane as the subspace, and
the generation processing of the impulse response includes:
calculating the impulse response in the subspace; and
adding, to the impulse response, an amplitude attenuation rate and a delay time according to a difference between a distance on a diffraction path between the sound source and the sound receiving point and a distance on a diffraction path between the sound source and the projection point.

18. The acoustic processing method according to claim 3, wherein
in the setting processing of the subspace, a two-dimensional space including the sound source and the sound receiving point on a same plane is set as the subspace, and
the generation processing of the impulse response calculates the impulse response in the subspace.

19. The acoustic processing method according to claim 1, wherein
the generation processing of the diffracted sound enables acquiring an allowable propagation direction in which sound propagation is allowed on a basis of directivity of the sound source and constraining generation of the diffracted sound propagating in a direction other than the allowable propagation direction.

20. The acoustic processing method according to claim 1, wherein
the generation processing of the diffracted sound enables calculating a ratio of a direct sound reaching the sound receiving point from a sound-emitting site through a diffraction site and constraining generation of the diffracted sound for the sound-emitting site in which the ratio of the direct sound becomes larger than allowable criteria.

21. An acoustic processing apparatus comprising:
a path search unit that searches a diffraction path from a sound source to a sound receiving point; and
a signal processing unit that generates a diffracted sound acquired at the sound receiving point on a basis of a wave acoustic simulation with a simulation time constrained according to a distance of the diffraction path.

22. A computer-readable recording medium storing an acoustic processing program implemented by a computer, the acoustic processing program comprising:
searching a diffraction path from a sound source to a sound receiving point; and
generating a diffracted sound acquired at the sound receiving point on a basis of a wave acoustic simulation with a simulation time constrained according to a distance of the diffraction path.
